(19) United States
(12) Patent Application Publication
(10) Pub. No.: US 2025/0380272 A1
(43) Pub. Date: Dec. 11, 2025

(54) SYSTEM INFORMATION COVERAGE ENHANCEMENT VIA COMBINING AND REPETITION

(71) Applicant: QUALCOMM Incorporated, San Diego, CA (US)

(72) Inventors: In-Soo KIM, San Diego, CA (US); Yan ZHOU, San Diego, CA (US); Yi HUANG, San Diego, CA (US); Mostafa KHOSHNEVISAN, San Diego, CA (US)

(21) Appl. No.: 18/737,882

(22) Filed: Jun. 7, 2024

(51) Int. Cl. H04W 72/231; H04W 56/00; H04W 72/0446; H04W 74/0833

(52) U.S. Cl. CPC H04W 72/231; H04W 56/0015; H04W 72/0446; H04W 74/0833

(57) ABSTRACT

Certain aspects of the present disclosure provide techniques for enhancing coverage of system information via combining and repetition. A method generally includes receiving signaling indicative of a number of repetitions for a downlink shared channel, wherein the downlink shared channel comprises system information; and monitoring for repetitions of the downlink shared channel according to the number of repetitions.

### INTRODUCTION

### Field of the Disclosure

Aspects of the present disclosure relate to wireless communications, and more particularly, to techniques for enhancing coverage of downlink shared channels for system information via combining and repetition.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes receiving signaling indicative of a number of repetitions for a downlink shared channel, wherein the downlink shared channel comprises system information; and monitoring for repetitions of the downlink shared channel according to the number of repetitions.

Another aspect provides a method for wireless communications by an apparatus. The method includes sending signaling indicative of a number of repetitions for a downlink shared channel, wherein the downlink shared channel comprises system information; and sending repetitions of the downlink shared channel according to the number of repetitions.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example wireless communications system.

FIG. 6 depicts an example wireless communications system.

FIGS. 7A, 7B, and 7C depict various examples of multiplexing patterns for system information.

FIG. 8 depicts an example scheduling of downlink shared channels for system information.

FIGS. 9A and 9B depict examples of encodings for system information.

FIG. 10 depicts an example of a combining pattern for system information.

FIGS. 11A and 11B depict examples of repetition patterns for system information.

FIG. 12 depicts a process flow for communications in a network between a network entity and a device.

FIG. 13 depicts a process flow for communications in a network between a network entity and a device.

FIG. 14 depicts a method for wireless communications.

FIG. 15 depicts another method for wireless communications.

FIG. 16 depicts another method for wireless communications.

FIG. 17 depicts another method for wireless communications.

FIG. 18 depicts another method for wireless communications.

FIG. 19 depicts another method for wireless communications.

FIG. 20 depicts aspects of an example communications device.

FIG. 21 depicts aspects of an example communications device.

### DETAILED DESCRIPTION

Aspects of the present disclosure provide apparatuses, methods, processing systems, and computer-readable mediums for enhancing coverage of downlink shared channels for system information via combining and/or repetition.

In some wireless communications systems, various types of system information may be delivered through different channels and/or mechanisms. For example, a network entity (e.g., base station) may send a master information block (MIB) via a physical broadcast channel (PBCH) (e.g., a periodically broadcasted channel, such as according to a configured or defined periodicity). In some aspects, the MIB may include information and parameters for a device to receive subsequent system information transmissions from the network entity, such as one or more system information blocks (SIBs).

Additionally, the network entity may send a first SIB (SIB1) via a physical downlink shared channel (PDSCH) scheduled by a physical downlink control channel (PDCCH) associated with a first common search space (CSS) (e.g., a Type0-CSS). In some aspects, the network entity may also periodically broadcast the SIB1 according to a configured or defined periodicity. As described herein, the SIB1 may include and/or carry remaining system information (RMSI). Additionally, the network entity may send one or more additional SIBs (e.g., a second SIB (SIB2) up to a ninth SIB (SIB9)) via a PDSCH scheduled by a PDCCH associated with a second CSS (e.g., Type0A-CSS). In some aspects, the network entity may send the one or more additional SIBs via an on-demand delivery based on receiving a request from the device (e.g., physical random access channel (PRACH) message or request). As described herein, the one or more additional SIBs may include and/or carry other system information (OSI).

In some aspects, the PDCCH that schedules the PDSCHs carrying the SIBs (e.g., RMSI and/or OSI PDSCHs, such as carrying the SIB1 and/or the one or more additional SIBs) may include a downlink control information (DCI) format 1_0 with a cyclic redundancy check (CRC) scrambled by a system information radio network temporary identifier (SI-RNTI). For example, for the scheduled PDSCH(s), the DCI format 1_0 may include a frequency domain resource assignment (e.g., variable number of bits based on size of a first control resource set (CORESET), such as a CORESET 0); a time domain resource assignment (e.g., four bits); a virtual resource block (VRB)-to-physical resource block (PRB) mapping (e.g., one bit); a modulation and coding scheme (MCS) (e.g., five bits); a redundancy version (e.g., two bits); a system information indicator (e.g., one bit); and a set of reserved bits (e.g., 12 bits for operation in a cell with shared spectrum channel access in a first frequency range (FR), such as FR1, or for operation in a cell in a second FR, such as FR2-2; otherwise 15 bits).

In some cases, the PDCCH that schedules the RMSI and/or OSI PDSCH may create a coverage bottleneck (e.g., in FR2) due to a coarse beam direction stemming from broadcasting the PDCCH. For example, the network entity may broadcast the PDCCH over a wide area using coarse beams (e.g., beamformed transmissions, such as unrefined beams or beams having a beam width that satisfies a first threshold), where broadcasting the PDCCH may occupy a high amount of time-frequency resources and/or create higher latency for a device to detect and decode the scheduling information in the PDCCH.

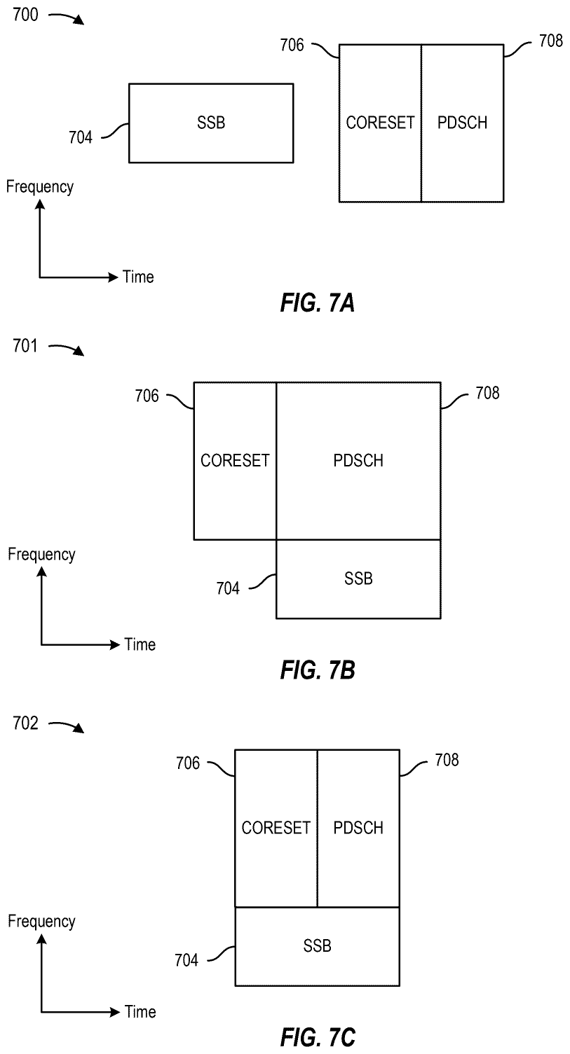

As described herein, one or more technical problems arise when sending and receiving PDSCH(s) carrying RMSI and/or OSI. For example, the RMSI and/or OSI PDSCH(s) may become the coverage bottleneck when a payload for the RMSI and/or OSI is quite large (e.g., the payload includes a large amount of bytes for the RMSI and/or OSI). In some aspects, the RMSI and/or OSI PDSCHs may be confined to a set of time resources and/or frequency resources (e.g., based on a synchronizations signal block (SSB) multiplexing pattern as described with reference to FIGS. 7A-7C), such that the large payload size of the RMSI and/or OSI PDSCHs becomes hard to fit within the confined resources. Table 1 (provided below) includes different example payload sizes (e.g., indicated in bytes with respect to transport block size (TBS) for a respective PDSCH carrying the system information) for RMSI and OSI (e.g., in FR1) for different resource block (RB) allocations and MCSs.

TABLE 1
Example RMSI/OSI Payload Sizes

| RMSI | | | OSI | | | |
|---|---|---|---|---|---|---|
| | | TBS | | | | TBS |
| RB | MCS | (Bytes) | SIB Mapping | RB | MCS | (Bytes) |
| 16 | 5 | 177 | SIB2 + SIB4 | 4 | 5 | 44 |
| | | | SIB5 | 20 | 5 | 225 |
| 13 | 4 | 123 | SIB2 + SIB3 + SIB5 | 22 | 0 | 80 |
| 28 | 0 | 101 | SIB2 + SIB5 | 12 | 0 | 42 |

As shown in Table 1, the payload sizes of an RSMI PDSCH may be large (e.g., up to 177 bytes for a TBS of the RMSI PDSCH). Additionally, the payload sizes of an OSI PDSCH may also be large (e.g., up to 225 bytes for a TBS of the OSI PDSCH). Accordingly, when the payload sizes of the RMSI and/or OSI PDSCH(s) become large, higher amounts of time-frequency resources may be allocated by a network entity to carry the PDSCH(s), which may reduce the amount of resources available for other communications (e.g., especially when the amount of available resources is limited, such as for different SSB multiplexing patterns). Additionally or alternatively, a device may expend higher amounts of processing power to detect and decode the PDSCH(s), thereby increasing a burn rate of battery power at the device and/or decreasing an operating time of the device on a charge.

Accordingly, in certain aspects, techniques and signaling described herein may provide a technical solution for sending and receiving PDSCH(s) carrying RMSI and/or OSI. For example, a device (e.g., a user equipment (UE)) may receive a system information downlink control channel (e.g., a PDCCH), in a first transmission occasion (e.g., one or more time-frequency resources configured that may include the system information downlink control channel), where the system information downlink control channel includes scheduling information for a plurality of system information downlink shared channels (e.g., PDSCHs). The device may then monitor the plurality of system information downlink shared channels based on the scheduling information. For example, the scheduling information may indicate time-frequency resources that are scheduled to carry the plurality of system information downlink shared channels, such that the device monitors the time-frequency resources for the plurality of system information downlink shared channels. Subsequently, the device may receive system information based on combining decoded signals received via the plurality of system information downlink shared channels.

In some aspects, the scheduling information may include an increase in a number of time periods (e.g., symbols) that include downlink shared channels that carry system information compared to previous configurations of time-frequency resources scheduled to carry system information downlink shared channels. For example, without the scheduling information, a system information downlink shared channel may be periodically sent with a system information downlink control channel during transmission occasions when a synchronization signal block (SSB) is sent, where the system information downlink shared channel and the system information downlink control channel each span a number of time periods. Subsequently, the scheduling information may increase the number of time periods for the system information downlink shared channels by allocating time periods which would have otherwise been scheduled for one or more system information downlink control channels to now include the system information downlink shared channels.

In some aspects, the device may receive a MIB that includes additional scheduling information for system information (e.g., the system information downlink control channel and the plurality of system information downlink shared channels). For example, the additional scheduling information may include a range of frequencies and a subset of transmission occasions (e.g., configured time resources) for the device to monitor for the plurality of system information downlink shared channels to receive the system information.

Additionally or alternatively, the device may receive signaling that indicates a number of repetitions for a downlink shared channel that includes system information. In some aspects, the number of repetitions may enable slot aggregation for the downlink shared channel at the device. Subsequently, the device may monitor for repetitions of the downlink shared channel according to the number of repetitions and may receive the system information based on the monitoring.

The techniques and signaling described previously may include various types of combining (e.g., aggregating multiple instances or transmissions of a message) and/or repetition (e.g., sending a message using multiple instances or transmissions) mechanisms to enhance coverage of PDSCH(s) carrying the RMSI and/or OSI. For example, a network entity may send an RMSI PDCCH (e.g., system information downlink control channel), to a device, that includes scheduling information for a plurality of RMSI PDSCHs (e.g., plurality of system information downlink shared channels), where the scheduling information includes an increase in a number of symbols for the plurality of RMSI PDSCHs compared to previous configurations of time-frequency resources scheduled to carry system information downlink shared channels as described previously. Subsequently, the device may receive RMSI based on combining successfully decoded portions from each RMSI PDSCH of the plurality of RMSI PDSCHs. Additionally or alternatively, the device may receive a MIB that includes additional scheduling information for RMSI (e.g., a range of frequencies or RBs, and a subset of transmission occasions) to facilitate RMSI PDSCH and/or RMSI PDCCH combining by indicating which time-frequency resources to buffer and/or combine for RMSI PDSCHs and/or RMSI PDCCHs. Additionally or alternatively, the device may receive signaling that indicates a number of repetitions for an RMSI and/or OSI PDSCH (e.g., downlink shared channel that includes system information).

The techniques for combining and/or repetition to enhance coverage of PDSCH(s) carrying the RMSI and/or OSI as described herein may provide any of various beneficial effects and/or advantages. For example, increasing the number of symbols may reduce coverage bottlenecks by allocating a higher number of resources (e.g., symbols, time-frequency resources, etc.) for the plurality of RMSI PDSCHs. Additionally, sending the RMSI over the plurality of RMSI PDSCHs may increase a likelihood that a device successfully decodes and receives the RMSI based on the device combining the RMSI across the plurality of RMSI PDSCHs. Additionally or alternatively, based on the device receiving the MIB that includes the additional scheduling information for RMSI, buffering at the device may be simplified based on limiting which time-frequency resources the device is intended to monitor for the RMSI PDSCH(s). For example, the device may perform less blind decoding and/or buffer fewer resources to detect and receive the RMSI, thereby reducing power consumption for the device, decreasing a burn rate of battery power at the device, and/or increasing an operating time of the device on a charge.

Additionally or alternatively, the signaling that indicates a number of repetitions for an RMSI and/or OSI PDSCH may enable slot aggregation for a device attempting to receive the RMSI and/or OSI PDSCH. For example, enabling slot aggregation may refer to enabling a data transmission (e.g., the RMSI and/or OSI PDSCH) to span multiple time periods (e.g., slots), such as a network entity sending a same transport block (TB) across a configurable number of consecutive time periods (e.g., corresponding to the indicated number of repetitions as described herein). In some aspects, the slot aggregation may increase a likelihood that the device successfully decodes and receives the RMSI and/or OSI based on the device combining the RMSI and/or OSI across the number of repetitions of the RMSI and/or OSI PDSCH. Subsequently, the device may reduce power consumption based on the enabled slot aggregation (e.g., rather than the device needing to request and/or monitor for retransmissions of the RMSI and/or OSI PDSCH).

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

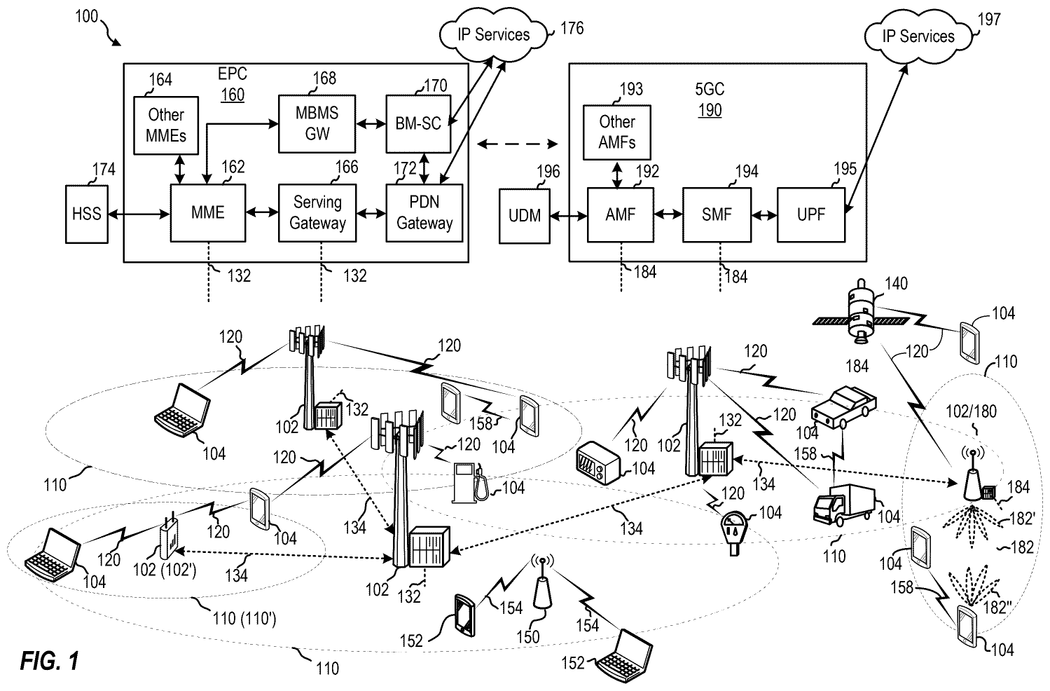

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

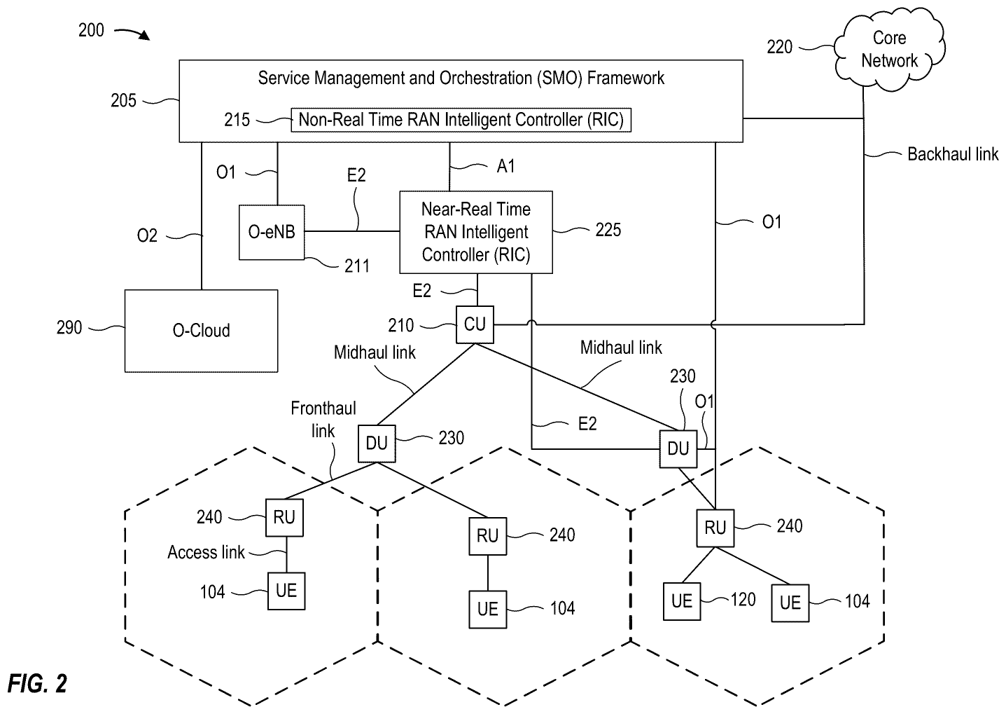

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

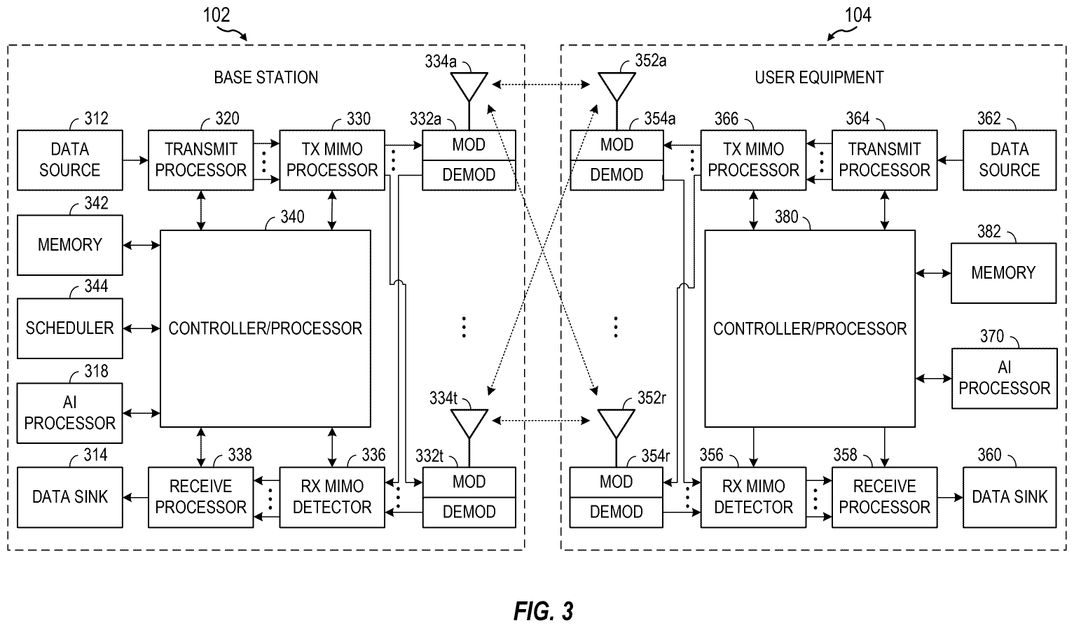

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

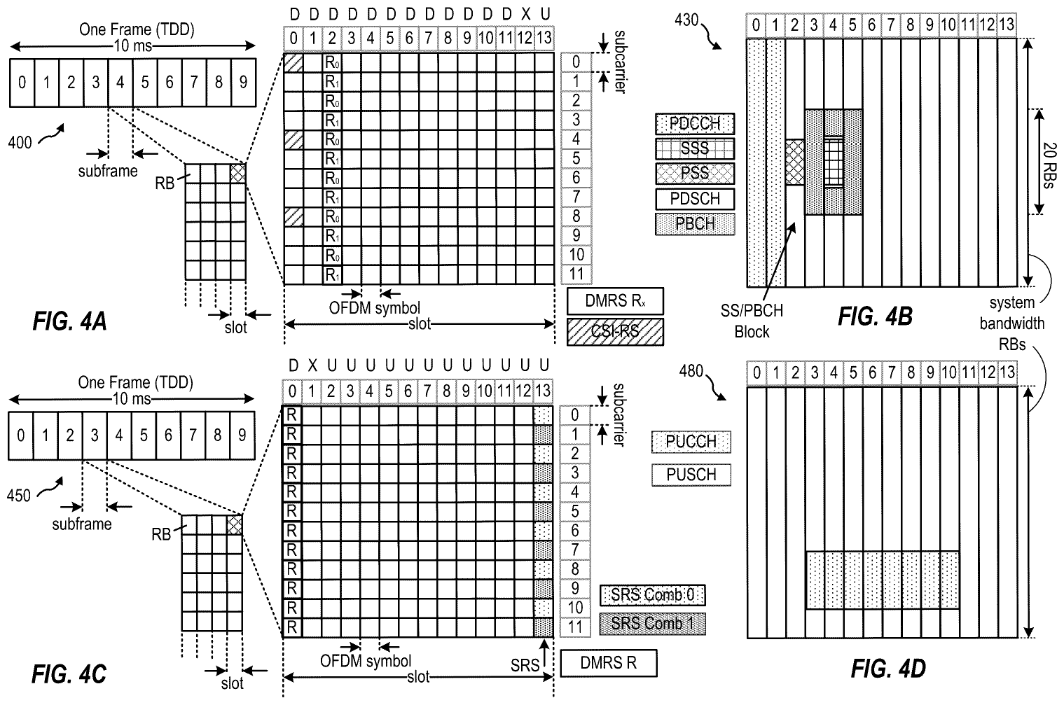

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, Uis UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 24× 15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Enhancing Coverage of Downlink Shared Channels for System Information Via Combining and Repetition

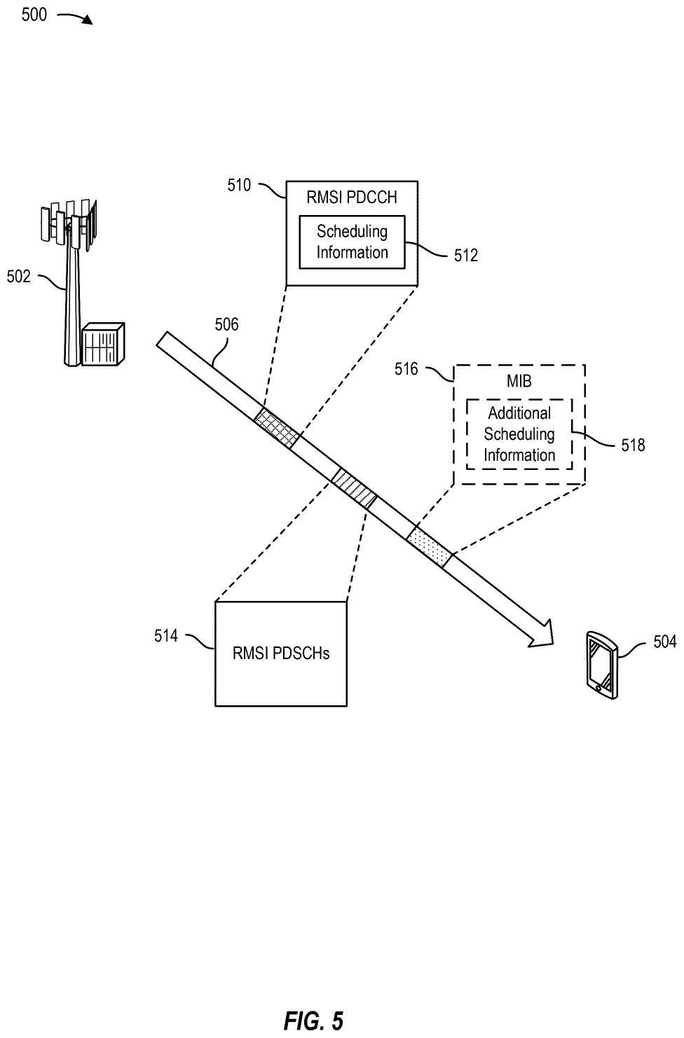

FIG. 5 depicts an example wireless communications system 500 for enhancing coverage of downlink shared channels for system information via combining and/or repetition in accordance with aspects of the present disclosure. In some aspects, the wireless communications system 500 may implement aspects of or may be implemented by aspects of FIGS. 1-4D. For example, the wireless communications system 500 may include a network entity 502 and at least one device 504, where the network entity 502 may represent a base station or similar network entity as described with reference to FIGS. 1-3 (e.g., BS 102, BS 180, etc.) and the device 504 may represent a UE or similar terminal device as described with reference to FIGS. 1-3 (e.g., UE 104). Additionally, the network entity 502 and the device 504 may wirelessly communicate via a downlink communication link 506 (e.g., one or more carriers, a communication link 120, beamforming 182, etc.). While only one device 504 is depicted in the example of FIG. 5, the network entity 502 may communicate with multiple devices.

As described previously, an RMSI PDSCH may become a coverage bottleneck for communications between the network entity 502 and the device 504 if a payload size of the RMSI PDSCH becomes large. As will be described with reference to FIGS. 7B and 7C, SSB multiplexing patterns may confine the RMSI PDSCH within a time resource allocation for an SSB, such that an amount of available resources for carrying the RMSI PDSCH is limited. Additionally or alternatively, the RMSI PDSCH may be the coverage bottleneck depending on an operating signal-to-noise ratio (SNR). For example, if the operating SNR is low (e.g., a higher amount of noise is present, which may impact signal quality and/or signal power of the RMSI PDSCH), the device 504 may be unable to successfully decode and receive the RMSI.

Accordingly, as described herein, the device 504 may receive an RMSI PDCCH 510 (e.g., from the network entity 502, such as via the downlink communication link 506), where the RMSI PDCCH 510 includes scheduling information 512 for a plurality of RMSI PDSCHs 514 in a plurality of transmission occasions. Subsequently, the device 504 may monitor for and receive the RMSI by monitoring the plurality of transmission occasions indicated in the scheduling information 512 as including the plurality of RMSI PDSCHs 514. In some aspects, the network entity 502 may indicate the plurality of transmission occasions in the scheduling information 512 via a DCI or a time-domain resource allocation (TDRA) table in the RMSI PDCCH 510. For example, the DCI may be a DCI format 1_0 as described previously, and one or more reserved bits of the set of reserved bits included in the DCI format 1_0 may be used to indicate the plurality of transmission occasions. Additionally or alternatively, the TDRA table may include a plurality of patterns of transmission occasions mapped to respective index values, and the RMSI PDCCH 510 may include an index value of the TDRA table to indicate which pattern of transmission occasions are used for the plurality of transmission occasions.

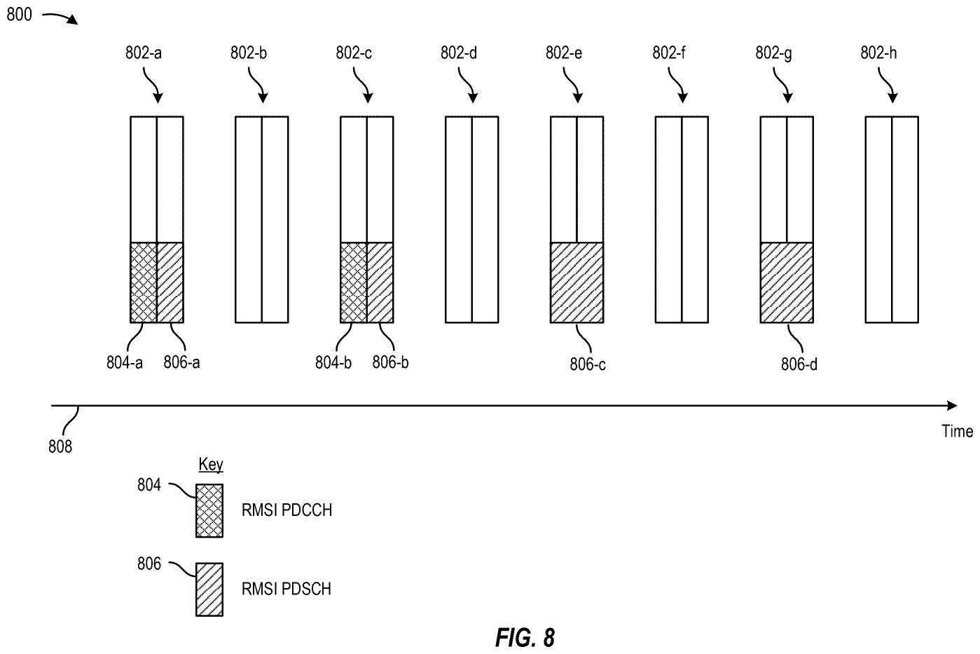

In some aspects, as described with reference to FIG. 8, the scheduling information 512 may increase (e.g., as described previously) a number of time periods or symbols allocated to the plurality of RMSI PDSCHs 514 (e.g., the plurality of transmission occasions) compared to a number of symbols allocated to the RMSI PDCCH 510. Subsequently, the increased number of symbols allocated to the plurality of RMSI PDSCHs 514 based on the plurality of transmission occasions indicated in the scheduling information 512 may enable a higher amount of combining of PDSCHs carrying the RMSI for the device 504. For example, the device 504 may decode and receive the RMSI based on combining multiple RMSI PDSCHs 514 across the plurality of transmission occasions.

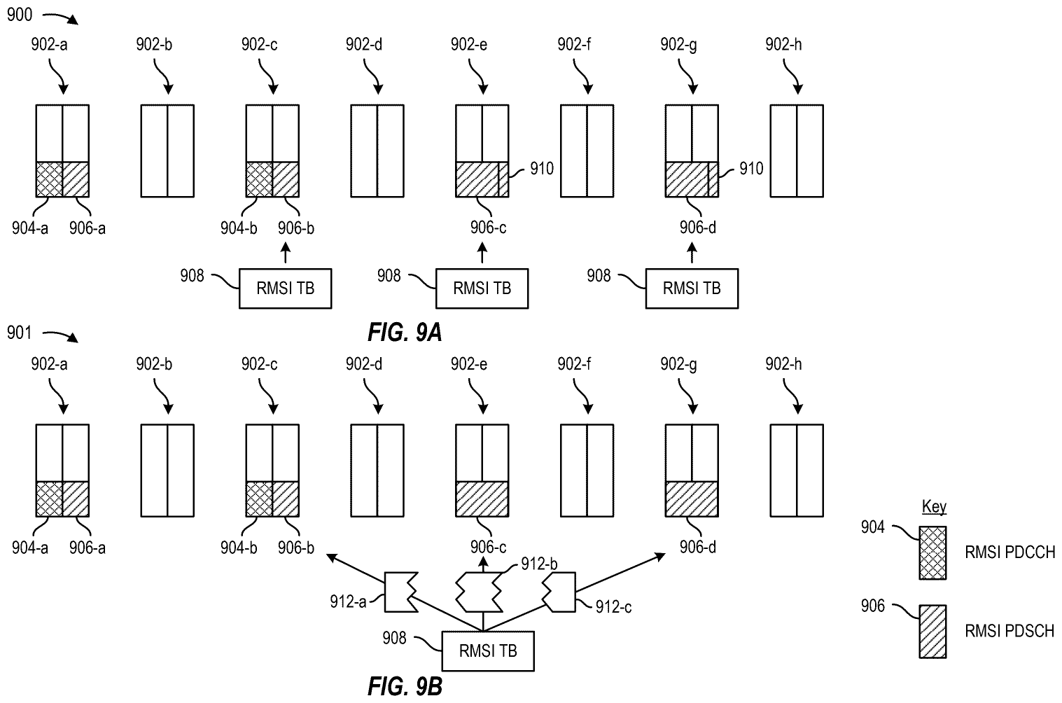

As described with reference to FIG. 9A, each of the plurality of RMSI PDSCHs 514 may include a respective instance of the RMSI (e.g., a set of coded bits), where the device 504 decodes the RMSI based on combining each respective instance of the RMSI. In such aspects, the RMSI PDCCH 510 may indicate a plurality of parameters for the plurality of RMSI PDSCHs 514. For example, the plurality of parameters may include a code rate that is common across the plurality of transmission occasions, a respective modulation scheme for each transmission occasion of the plurality of transmission occasions, a repetition parameter to indicate at least part of a set of coded bits that are repeated for one or more transmission occasions of the plurality of transmission occasions, or a combination thereof, for the plurality of RMSI PDSCHs 514.

Additionally or alternatively, as described with reference to FIG. 9B, the RMSI may be distributed across the plurality of RMSI PDSCHs 514. Accordingly, the device 504 may decode and receive the RMSI based on combining the RMSI distributed across the plurality of RMSI PDSCHs 514. In such aspects, the RMSI PDCCH 510 may include an indication of how the RMSI is distributed across the plurality of transmission occasions.

In some aspects, the device 504 may also or alternatively receive a MIB 516 (e.g., from the network entity 502, such as via the downlink communication link 506) that indicates an RMSI PDCCH and/or PDSCH combining pattern in the time and/or frequency domain to facilitate or simplify combining of the RMSI PDCCH 510 and/or the plurality of RMSI PDSCHs 514. For example, the device 504 may not have information of where transmission of the RMSI PDCCH 510 and/or the plurality of RMSI PDSCHs 514 occurs (e.g., other than somewhere in a first CORESET, such as CORESET0, and a first search space, such as search space 0). As such, to combine and decode the RMSI PDCCH 510 and/or the plurality of RMSI PDSCHs 514, the device 504 may buffer an entire bandwidth of a CORESET (e.g., which may be as wide as 69.12 megahertz (MHz) in FR2) and possible transmission occasions that might carry the RMSI PDCCH 510 and/or the plurality of RMSI PDSCHs 514, which may not be feasible for low-end or low-tier devices (e.g., devices with lower processing capabilities and/or memory storage capacities) in terms of memory, energy efficiency, etc. Additionally, for some SSB multiplexing patterns (e.g., as described with reference to FIGS. 7B and 7C), an RMSI PDSCH may be confined within a time-resource allocation for an SSB, which may prevent repetitions of the RMSI PDSCH from being sent (e.g., the time-resource allocation of the SSB does not allow room for repetition of the RMSI PDSCH). Additionally, issues may arise for combining of the RMSI PDCCH, such as the device 504 not knowing which PDCCH candidates should be combined among a plurality of detected PDCCH candidates when the RMSI and one or more paging PDCCHs share a same search space.

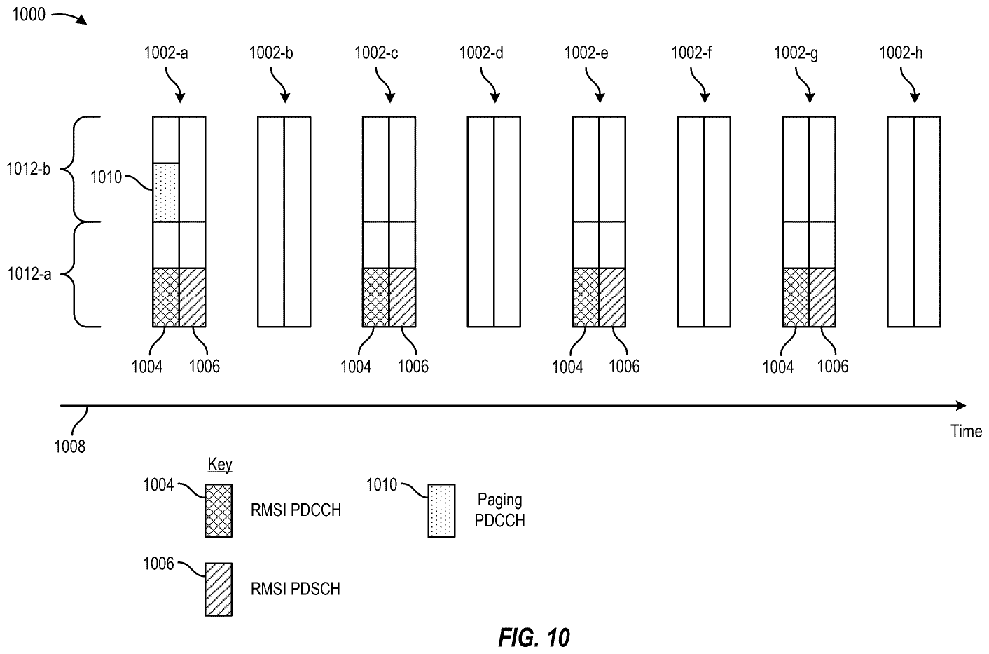

Accordingly, the MIB 516 may include additional scheduling information 518 to enable the device 504 to combine an RMSI PDCCH and/or an RMSI PDSCH across a transmission time interval (TTI) configured for the RMSI (e.g., a 160 millisecond (ms) RMSI TTI). For example, the additional scheduling information 518 may narrow down a possible RB range and/or a number of transmission occasions on which the device 504 should expect to monitor and receive the RMSI PDCCH 510 and/or the plurality of RMSI PDSCHs 514. Accordingly, the additional scheduling information 518 may simplify PDCCH and/or PDSCH buffering at the device 504 based on the device 504 not having to buffer the entire bandwidth of a CORESET and possible transmission occasions that might carry the RMSI PDCCH 510 and/or the plurality of RMSI PDSCHs 514. Details of the additional scheduling information 518 is described in greater detail with reference to FIG. 10.

For example, the additional scheduling information 518 may facilitate the combining of the plurality of RMSI PDSCHs 514 by indicating which transmission occasions the device 504 is to buffer for detecting and receiving the plurality of RMSI PDSCHs 514 (e.g., a subset of transmission occasions, such as even SSB bursts or odd SSB bursts). Additionally or alternatively, the additional scheduling information 518 may simplify PDSCH buffering at the device 504 by restricting the RBs of interest (e.g., a first half of RBs or a second half of RBs within a CORSET). Further, in certain aspects, the additional scheduling information 518 may assist the device 504 to determine which PDCCH candidates should be combined among detected PDCCH candidates when two PDCCHs share a same search space (e.g., RMSI PDCCH 510 and a paging PDCCH).

In some aspects, the MIB 516 and the additional scheduling information 518 may shift block error rate (BLER) curves of both the RMSI PDCCH 510 and the plurality of RMSI PDSCHs 514 by a same amount (e.g., three decibels (dB)). For example, BLER may refer to a ratio of a number of TBs received in error to a total number of TBs transmitted over a certain time (e.g., a certain number of frames), and the BLER curves may represent how a BLER changes or is expected to change for different SNR values (e.g., measured in dBs) for a corresponding channel (e.g., RMSI PDCCH 510 or RMSI PDSCHs 514). Accordingly, shifting the BLER curves may correspond to achieving lower BLERs (e.g., fewer TBs received in error in relation to a total number of TBs transmitted) for a given SNR value. For example, if a BLER curve is shifted by 3 dBs, a first BLER value (e.g., 0.01) may be shifted from corresponding to a first SNR value (e.g., 20 dBs) to corresponding to a second SNR value (e.g., 17 dBs), and a second BLER value (e.g., 0.001 or another value less than 0.01) may be shifted to correspond to the first SNR value. In some aspects, the MIB 516 and the additional scheduling information 518 may shift the BLER curves of both the RMSI PDCCH 510 and the plurality of RMSI PDSCHs 514 based on the device 504 having more information on where the RMSI PDCCH 510 and the plurality of RMSI PDSCHs 514 are located, which may reduce the number of TBs received in error.

In some aspects, shifting the BLER curves of both the RMSI PDCCH 510 and the plurality of RMSI PDSCHs 514 by a same amount may result in the RMSI PDSCHs 514 still being a coverage bottleneck for the device 504 (e.g., depending on an operating SNR). For example, improving the BLERs for both the RMSI PDCCH 510 and the plurality of RMSI PDSCHs 514 by a same amount for a given SNR may not reduce a number of TBs received in error for the plurality of RMSI PDSCHs 514 in relation to a number of TBs received in error for the RMSI PDCCH 510. As such, a higher number of bits and/or time-frequency resources may still be needed for the plurality of RMSI PDSCHs 514 in relation to a number of bits and/or time-frequency resources needed for the RMSI PDCCH 510.

As such, increasing the number of symbols allocated to the plurality of RMSI PDSCHs 514 (e.g., based on the scheduling information 512 described previously) may improve a BLER curve of the plurality of RMSI PDSCHs 514 by an amount greater than that of a BLER curve of the RMSI PDCCH 510. For example, the increased number of symbols may result in a smaller BLER of the RMSI PDSCHs 514 for an SNR value in relation to a BLER of the RMSI PDCCH 510 for the SNR value based on enabling the device 504 to combine the plurality of RMSI PDSCHs 514 over the increased number of symbols. That is, enabling the device 504 to combine the plurality of RMSI PDSCHs 514 over the increased number of symbols may result in fewer TBs received in error for the plurality of RMSI PDSCHs 514.

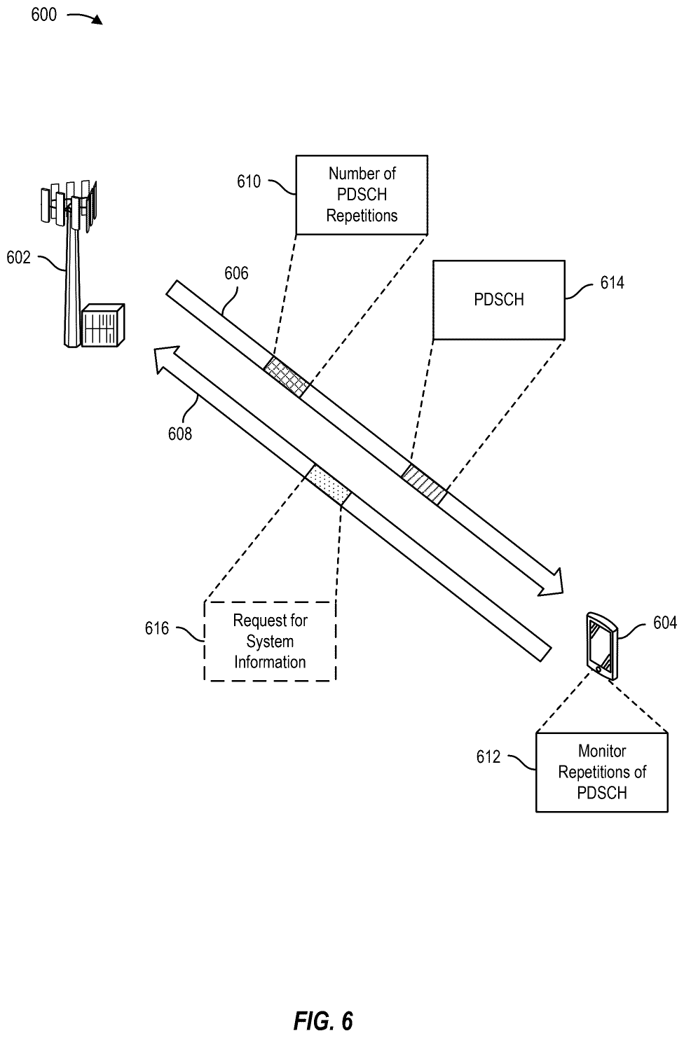

FIG. 6 depicts an example wireless communications system 600 for enhancing coverage of downlink shared channels for system information via repetition in accordance with aspects of the present disclosure. In some aspects, the wireless communications system 600 may implement aspects of or may be implemented by aspects of FIGS. 1-5. For example, the wireless communications system 600 may include a network entity 602 and at least one device 604, where the network entity 602 may represent a base station or similar network entity as described with reference to FIGS. 1-3 (e.g., BS 102, BS 180, etc.) and the device 604 may represent a UE or similar terminal device as described with reference to FIGS. 1-3 e.g., UE 104). Additionally, the network entity 602 and the device 604 may wirelessly communicate via a downlink communication link 606 (e.g., one or more carriers, a communication link 120, beamforming 182, etc.) and via an uplink communication link 608 (e.g., one or more carriers, a communication link 120, beamforming 182, etc.). While only one device 604 is depicted in the example of FIG. 6, the network entity 602 may communicate with multiple devices.

In some cases, a TDRA with a repetition parameter (e.g., repetitionNumber-r16) may indicate slot aggregation is enabled for the device 504 and may be available for unicast shared channels (e.g., PxSCH, such as a PDSCH and/or a physical uplink shared channel (PUSCH). However, there may not be a slot aggregation configuration for an RMSI PDSCH. For example, as described previously, an RMSI PDCCH and/or OSI PDCCH that schedules an RSMI PDSCH and/or OSI PDSCH, respectively, may include a DCI format 1_0 with a CRC scrambled by an SI-RNTI, but a slot aggregation field may not be present in the DCI format 1_0. Table 2 (provided below) includes example TDRAs with no slot aggregation field for the DCI format 1_0 for different CSSs (e.g., Type0-CSS and Type0A-CSS).

TABLE 2
Example PDSCH TDRAs

| | | | PDSCH- | PDSCH-Config | |
|---|---|---|---|---|---|
| | | SSB | ConfigCommon | includes pdsch- | |
| | PDCCH | Multiplex- | includes pdsch- | TimeDomainAllo- | |
| | Search | ing | TimeDomainAllo- | cationListForMul- | PDSCH TDRA to |
| RNTI | Space | Pattern | cationList | tiPDSCH | Apply |
| SI- | Type0 | 1 | — | — | Default A for Normal |
| RNTI | Common | | | | CP |
| | | 2 | — | — | Default B |
| | | 3 | — | — | Default C |
| SI- | Type0A | 1 | No | — | Default A |
| RNTI | Common | 2 | No | — | Default B |
| | | 3 | No | — | Default C |
| | | 1, 2, 3 | Yes | — | Pdsch- |
| | | | | | TimeDomainAllocation |
| | | | | | List provided in |
| | | | | | PDSCH- |
| | | | | | ConfigCommon |

Accordingly, as described herein, to introduce slot aggregation for an RMSI PDSCH and/or OSI PDSCH, the device 604 may receive signaling 610 (e.g., from the network entity 602, such as via the downlink communication link 606) that is indicative of a number of repetitions for a PDSCH 614, where the PDSCH 614 may include RMSI or OSI. In some aspects, the device 604 may then perform a monitoring 612 for repetitions of the PDSCH 614 according to the number of repetitions. Subsequently, the device 604 may receive the PDSCH 614 based on the monitoring 612 for the repetitions of the PDSCH 614. In some aspects, the repetitions of the PDSCH 614 may be used for a SSB multiplexing pattern as described with reference to FIG. 7A (e.g., the repetitions of the PDSCH 614 are time-division multiplexed (TDMed) with a SSB).

In some aspects, the signaling 610 may include a DCI field in a PDCCH that schedules the PDSCH 614. For example, the PDCCH may be a DCI format 1_0 as described previously, and one or more reserved bits of the set of reserved bits included in the DCI format 1_0 may be used to indicate the number of repetitions. Additionally or alternatively, the signaling 610 may include a TDRA table in the PDCCH, where the TDRA table includes a slot aggregation field indicating the number of repetitions. For example, the TDRA table may include a plurality of patterns of transmission occasions mapped to respective index values, and the PDCCH may include an index value of the TDRA table to indicate which pattern of transmission occasions and/or a slot aggregation field indicating the number of repetitions. In such aspects, the PDSCH 614 may include RMSI.

Additionally or alternatively, the device 604 may send a request 616 (e.g., to the network entity 602, such as via the uplink communication link 608) for system information. For example, the request may include a PRACH message. Additionally, the number of repetitions may be based on a preamble identifier in the request 616 (e.g., PRACH preamble identifier), a transmission occasion in which the request 616 is sent (e.g., PRACH occasion), or a combination thereof. In some aspects, the number of repetitions for the PDSCH 614 may be semi-statically configured (e.g., via RRC signaling, which may be signaled through RMSI, such as an RMSI PDSCH), and the device 604 may determine the number of repetitions via the semi-static configuration and based on the previously described parameters (e.g., PRACH preamble identifier, PRACH occasion, etc.). For example, the semi-static configuration may include different numbers of repetitions that are associated with different preamble identifiers and/or transmission occasions, such that the device 604 determines the number of repetitions based on which preamble identifier the device 604 uses for the request 616 and/or in which transmission occasion the request 616 is sent. In such aspects, the PDSCH 614 may include OSI.

### Example Multiplexing Patterns for System Information

FIGS. 7A, 7B, and 7C depict various examples of multiplexing patterns 700, 701, and 702, respectively, for system information. In some aspects, the multiplexing patterns 700, 701, and 702 may implement aspects of or may be implemented by aspects of FIGS. 1-6. For example, the multiplexing patterns 700, 701, and 702 may include multiplexing patterns for a network entity to send various types of system information to a device, such as RMSI and/or OSI, as described with reference to FIGS. 5 and 6.

In some cases, the network entity may periodically broadcast RMSI according to a predefined SSB multiplexing pattern (e.g., every 160 ms in an RMSI TTI). As described previously, a PDCCH (e.g., an RSMI PDCCH) that includes a DCI format 1_0 with a CRC scrambled by an SI-RNTI for a Type0-CSS may schedule a PDSCH carrying the RMSI (e.g., RMSI PDSCH). Additionally or alternatively, the network entity may deliver OSI upon a random access channel (RACH)-based request from the device (e.g., the request 616 as described with reference to FIG. 6), where the RACH-based request can be either contention-free random access (CFRA)-based or contention-based random access (CBRA)-based (e.g., depending on network configuration). Additionally, a PDCCH (e.g., OSI PDCCH) that includes a DCI format 1_0 with a CRC scrambled by an SI-RNTI for a TypeOA-CSS may schedule a PDSCH carrying the OSI (e.g., OSI PDSCH).

FIG. 7A depicts the multiplexing pattern 700, which is referred to as a first SSB multiplexing pattern (e.g., SSB multiplexing pattern 1), for communicating RMSI and/or OSI. For example, the first SSB multiplexing pattern TDMs an SSB 704 with a CORESET 706 (e.g., including a PDCCH for scheduling RMSI and/or OSI) and a PDSCH 708 (e.g., RMSI PDSCH and/or OSI PDSCH). In some aspects, the first SSB multiplexing pattern may be used in frequency range 1 (FR1) and/or FR2.

FIG. 7B depicts the multiplexing pattern 701, which is referred to as a second SSB multiplexing pattern (e.g., SSB multiplexing pattern 2), for communicating RMSI and/or OSI. For example, the second SSB multiplexing pattern TDMs and/or FDMs the SSB 704 with the CORESET 706 (e.g., including a PDCCH for scheduling RMSI and/or OSI) and the PDSCH 708 (e.g., RMSI PDSCH and/or OSI PDSCH). In some aspects, the PDSCH 708 may be confined within a time-resource allocation for the SSB 704 for the second multiplexing pattern.

In some aspects, the second SSB multiplexing pattern may be used in FR2. Additionally, for a subcarrier spacing (SCS) of 120 kilohertz (kHz) for the SSB 704 and an SCS of 60 kHz for the CORESET 706 and the PDSCH 708, the CORESET 706 may span one symbol, and the PDSCH 708 may span two symbols. Similarly, for an SCS of 240 kHz for the SSB 704 and an SCS of 120 kHz for the CORESET 706 and the PDSCH 708, the CORESET 706 may span one symbol, and the PDSCH 708 may span two symbols.

As described previously, the PDSCH 708 may become a coverage bottleneck over a PDCCH (e.g., in the CORESET 706) that schedules the PDSCH 708. As an example, for the second SSB multiplexing pattern, an SCS of 240 kHz may be configured for the SSB 704, and an SCS of 120 kHz may be configured for the CORESET 706 and the PDSCH 708. The PDCCH (e.g., in the CORESET 706) may include 48 RBs and one symbol (e.g., with an aggregation level 8 (AL8)) with a 48-bit DCI including a CRC. Accordingly, a number of coded bits carried by the PDCCH may equal 864 bits based on 48 RBs×12 REs×1 symbol×2 bits (e.g., based on a Quadrature Phase Shift Keying (QPSK) modulation scheme)×75% (e.g., based on a demodulation reference signal (DMRS) overhead (OH))=864 bits. Subsequently, a code rate for the PDCCH may equal approximately 0.06 (e.g., 48/864≈0.06). Additionally, the PDSCH 708 may include 48 RBs and two symbols with 800 bits for RMSI. Accordingly, a number of coded bits carried by the PDSCH 708 may equal 1728 bits based on 48 RBs×12 REs×2 symbols×2 bits (e.g., based on a QPSK modulation scheme)×75% (e.g., based on a one symbol type 1 DMRS OH)=1728 bits. Subsequently, a code rate for the PDSCH 708 may equal approximately 0.46 (e.g., 800/1728≈0.46). As such, the higher code rate for the PDSCH may result in the coverage bottleneck described herein.

FIG. 7C depicts the multiplexing pattern 702, which is referred to as a third SSB multiplexing pattern (e.g., SSB multiplexing pattern 3), for communicating RMSI and/or OSI. For example, the third SSB multiplexing pattern FDMs the CORESET 706 (e.g., including a PDCCH for scheduling RMSI and/or OSI) and the PDSCH 708 (e.g., RMSI PDSCH and/or OSI PDSCH) with the SSB 704. In some aspects, the PDSCH 708 and the CORESET 706 may be confined within a time-resource allocation for the SSB 704 for the third multiplexing pattern.

In some aspects, the third SSB multiplexing pattern may be used in FR2. Additionally, for an SCS of 120 kHz for the SSB 704 and an SCS of 120 kHz for the CORESET 706 and the PDSCH 708, the CORESET 706 may span two symbols, and the PDSCH 708 may span two symbols.

For the third SSB multiplexing pattern, the PDSCH 708 may also become a coverage bottleneck over a PDCCH (e.g., in the CORESET 706) that schedules the PDSCH 708. As an example, for the third SSB multiplexing pattern, an SCS of 120 kHz may be configured for the SSB 704, and an SCS of 120 kHz may be configured for the CORESET 706 and the PDSCH 708. The PDCCH (e.g., in the CORESET 706) may include 48 RBs and two symbol (e.g., with an aggregation level 16 (AL16)) with a 48-bit DCI including a CRC. Accordingly, a number of coded bits carried by the PDCCH may equal 1728 bits based on 48 RBs×12 REs×2 symbols×2 bits (e.g., based on a QPSK modulation scheme)×75% (e.g., based on a DMRS OH)=1728 bits. Subsequently, a code rate for the PDCCH may equal approximately 0.03 (e.g., 48/1728≈0.03). Additionally, the PDSCH 708 may include 48 RBs and two symbols with 800 bits for RMSI. Accordingly, a number of coded bits carried by the PDSCH 708 may equal 1728 bits based on 48 RBs×12 REs×2 symbols×2 bits (e.g., based on a QPSK modulation scheme)×75% (e.g., based on a one symbol type 1 DMRS OH)=1728 bits. Subsequently, a code rate for the PDSCH 708 may equal approximately 0.46 (e.g., 800/1728≈0.46). As such, the higher code rate for the PDSCH 708 may result in the coverage bottleneck as described herein for the third SSB multiplexing pattern.

### Example Combination Patterns for System Information

FIG. 8 depicts an example scheduling 800 of downlink shared channels for enhancing coverage of downlink shared channels for system information via combination in accordance with aspects of the present disclosure. In some aspects, the scheduling 800 may implement aspects of or may be implemented by aspects of FIGS. 1-5 and 7A-7C. For example, the scheduling 800 may represent a device receiving an RMSI PDCCH (e.g., from a network entity), where the RMSI PDCCH includes scheduling information for a plurality of RMSI PDSCHs in a plurality of transmission occasions as described with reference to FIG. 5.

In the example of FIG. 8, a set of transmission occasions 802 may be configured for an RMSI TTI 808 (e.g., 160 ms TTI), such as a first transmission occasion 802-a, a second transmission occasion 802-b, a third transmission occasion 802-c, a fourth transmission occasion 802-d, a fifth transmission occasion 802-e, a sixth transmission occasion 802-f, a seventh transmission occasion 802-g, and an eighth transmission occasion 802-h. Subsequently, the device may receive one or more RMSI PDCCHs 804 in at least one transmission occasion of the set of transmission occasions. For example, the device may receive a first RMSI PDCCH 804-a in the first transmission occasion 802-a and a second RMSI PDCCH 804-b in the third transmission occasion 802-c.

As described herein, the first RMSI PDCCH 804-a and/or the second RMSI PDDCH 804-b may include scheduling information for a plurality of RMSI PDSCHs 806 in a plurality of transmission occasions. For example, both the first RMSI PDCCH 804-a and the second RMSI PDCCH 804-b may include the scheduling information.

Accordingly, the scheduling information may indicate a first RMSI PDSCH 806-a is scheduled in the first transmission occasion 802-a, a second RMSI PDSCH 806-b is scheduled in the third transmission occasion 802-c, a third RMSI PDSCH 806-c is scheduled in the fifth transmission occasion 802-e, and a fourth RMSI PDSCH 806-d is scheduled in the seventh transmission occasion 802-g. Additionally, the plurality of transmission occasions may correspond to the first transmission occasion 802-a, the third transmission occasion 802-c, the fifth transmission occasion 802-e, and the seventh transmission occasion 802-g.

Additionally or alternatively, the first RMSI PDCCH 804-a may only include information that schedules the first RMSI PDSCH 806-a, while the second RMSI PDCCH 904-b includes the scheduling information described herein. In such a case, the scheduling information may indicate the second RMSI PDSCH 806-b is scheduled in the third transmission occasion 802-c, the third RMSI PDSCH 806-c is scheduled in the fifth transmission occasion 802-e, and the fourth RMSI PDSCH 806-d is scheduled in the seventh transmission occasion 802-g. Accordingly, in this case, the plurality of transmission occasions may correspond to the third transmission occasion 802-c, the fifth transmission occasion 802-e, and the seventh transmission occasion 802-g.

In some aspects, the first RMSI PDCCH 804-a and the first RMSI PDSCH 806-a (e.g., in the first transmission occasion 802-a) may each span two symbols. Similarly, the second RMSI PDCCH 804-b and the second RMSI PDSCH 806-b (e.g., in the third transmission occasion 802-c) may also each span two symbols. Additionally or alternatively, the third RMSI PDSCH 806-c (e.g., in the fifth transmission occasion 802-e) and the fourth RMSI PDSCH 806-d (e.g., in the seventh transmission occasion 802-g) may each span four symbols. That is, a first number of time-frequency resources allocated for one or more first RMSI PDSCH of the plurality of RMSI PDSCHs (e.g., the first RMSI PDSCH 806-a and the second RMSI PDSCH 806-b) may be different than a second number of time-frequency resources allocated for one or more second RMSI PDSCH of the plurality of RMSI PDSCHs (e.g., the third RMSI PDSCH 806-c and the fourth RMSI PDSCH 806-d). In some aspects, the RMSI PDCCH(s) 804 that schedule the RMSI PDSCHs 806 across multiple nonuniform transmission occasions may be distinguished from other PDCCHs and/or RMSI PDCCHs using a repurposed reserved field in the DCI 1_0 format with a CRC scrambled by the SI-RNTI for a Type0-CSS.

FIGS. 9A and 9B depict examples of encodings 900 and 901, respectively, for enhancing coverage of downlink shared channels for system information via combination and/or repetition in accordance with aspects of the present disclosure. In some aspects, the encodings 900 and 901 may implement aspects of or may be implemented by aspects of FIGS. 1-5 and 7A-8. For example, the encodings 900 and 901 may represent a device receiving an RMSI PDCCH (e.g., from a network entity), where the RMSI PDCCH includes scheduling information for a plurality of RMSI PDSCHs in a plurality of transmission occasions as described with reference to FIGS. 5 and 8.

In the examples of FIGS. 9A and 9B, a set of transmission occasions 902 may be configured for an RMSI TTI, such as a first transmission occasion 902-a, a second transmission occasion 902-b, a third transmission occasion 902-c, a fourth transmission occasion 902-d, a fifth transmission occasion 902-e, a sixth transmission occasion 902-f, a seventh transmission occasion 902-g, and an eighth transmission occasion 902-h. Subsequently, the device may receive one or more RMSI PDCCHs 904 in at least one transmission occasion of the set of transmission occasions. For example, the device may receive a first RMSI PDCCH 904-a in the first transmission occasion 902-a and a second RMSI PDCCH 904-b in the third transmission occasion 902-c. Additionally, the first RMSI PDCCH 904-a and/or the second RMSI PDDCH 904-b may include scheduling information for a plurality of RMSI PDSCHs 906 in a plurality of transmission occasions. For example, the scheduling information may indicate a first RMSI PDSCH 906-a is scheduled in the first transmission occasion 902-a, a second RMSI PDSCH 906-b is scheduled in the third transmission occasion 902-c, a third RMSI PDSCH 906-c is scheduled in the fifth transmission occasion 902-e, and a fourth RMSI PDSCH 906-d is scheduled in the seventh transmission occasion 902-g. Additionally, the second RMSI PDSCH 906-b may carry 864 resource elements (REs), the third RMSI PDSCH 906-c may carry 2016 REs, and the fourth RMSI PDSCH 906-d may carry 2016 REs (e.g., taking into account a DMRS OH).

In the example of FIG. 9A, each of the plurality of RMSI PDSCHs 906 may include a respective instance of a set of coded bits for the RMSI. For example, the second RMSI PDSCH 906-b, the third RMSI PDSCH 906-c, and the fourth RMSI PDSCH 906-d may each include an RMSI TB 908. In some aspects, the RMSI may be encoded with a same code rate at each respective transmission occasion 902. For example, the second RMSI PDSCH 906-b, the third RMSI PDSCH 906-c, and the fourth RMSI PDSCH 906-d may each include a same code rate for the RMSI TB 908.

In some aspects, to match a number of coded bits carried by the plurality of RMSI PDSCHs 906 across multiple nonuniform transmission occasions, a different modulation scheme may be used at each transmission occasion 902. That is, a first modulation scheme applied to one RMSI PDSCH 906 of the plurality of RMSI PDSCHs 906 may be different than a second modulation scheme applied to an additional RMSI PDSCH of the plurality of RMSI PDSCHs 906. For example, the second RMSI PDSCH 906-b may encode the RMSI TB 908 using a first modulation scheme (e.g., QPSK), and the third RMSI PDSCH 906-c and the fourth RMSI PDSCH 906-d may encode the RMSI TB 908 using a second modulation scheme (e.g., BPSK). In some aspects, the second RMSI PDSCH 906-b may include 1728 bits based on 48 RBs×12 REs×2 symbols×2 bits (e.g., based on the QPSK)×75% (e.g., based on a DMRS OH)=1728 bits. Additionally or alternatively, the third RMSI PDSCH 906-c and the fourth RMSI PDSCH 906-d may also include 1728 bits based on 48 RBs×12 REs×4 symbols×1 bit (e.g., based on the BPSK)×75% (e.g., based on a DMRS OH)=1728 bits.

Additionally or alternatively, if the number of coded bits carried by each of the plurality of RSMI PDSCHs 906 at each transmission occasion 902 is not the same (e.g., even with using different modulation schemes, a set of coded bits 910 may be repeated in a transmission occasion 902. For example, the third RMSI PDSCH 906-c and the fourth RMSI PDSCH 906-d may include additional space for the set of coded bits 910. As such, the third RMSI PDSCH 906-c and the fourth RMSI PDSCH 906-d may encode the RMSI over 2016 bits based on (1728+288)×1 bit (e.g., based on the BPSK)=2016 bits, where the set of coded bits 910 that are repeated include 288 bits repeated from the 1728 bits. Subsequently, log-likelihood ratios (LLRs) may be combinable across multiple nonuniform transmission occasions based on the different modulation schemes and repeated bits.

In the example of FIG. 9B, the RMSI TB 908 (e.g., set of coded bits) may be distributed across the plurality of RMSI PDSCHs 906. For example, the RMSI TB 908 may be encoded jointly across multiple nonuniform transmission occasions to lower a code rate of the RMSI. As shown, the RSMI TB 908 may be split into three parts 912, such as a first part 912-a sent via the second RMSI PDSCH 906-b in the third transmission occasion 902-c, a second part 912-b sent via the third RMSI PDSCH 906-c in the fifth transmission occasion 902-d, and a third part 912-c sent via the fourth RMSI PDSCH 906-d in the seventh transmission occasion 902-g. For example, the RMSI may be encoded over 9792 bits based on (864 bits for the second RMSI PDSCH 906-b+2016 bits for the third RMSI PDSCH 906-c+2016 bits for the fourth RMSI PDSCH 906-d)×2 (e.g., based on a QPSK modulation scheme=9792 bits, and the 9792 coded bits are distributed across the third transmission occasion 902-c, the fifth transmission occasion 902-d, and the seventh transmission occasion 902-g. Subsequently, the device may decode the RMSI after the coded bits are collected across the respective transmission occasions 902.

FIG. 10 depicts an example of a combining pattern 1000 for system information for enhancing coverage of downlink shared channels for system information via combination and/or repetition in accordance with aspects of the present disclosure. In some aspects, the combining pattern 1000 may implement aspects of or may be implemented by aspects of FIGS. 1-5 and 7A-9. For example, the combining pattern 1000 may represent a device receiving a MIB that narrows down a possible RB range and a number of transmission occasions on which the device should expect to monitor and receive an RMSI PDCCH and/or a plurality of RMSI PDSCHs as described with reference to FIG. 5.

In the example of FIG. 10, a set of transmission occasions 1002 may be configured for an RMSI TTI 1008, such as a first transmission occasion 1002-a, a second transmission occasion 1002-b, a third transmission occasion 1002-c, a fourth transmission occasion 1002-d, a fifth transmission occasion 1002-e, a sixth transmission occasion 1002-f, a seventh transmission occasion 1002-g, and an eighth transmission occasion 1002-h. Subsequently, the MIB may include a first bit (e.g., one bit) that indicates a possible RB range where one or more RMSI PDCCHs 1004 and one or more RMSI PDSCHs 1006 can occur. For example, the first bit may indicate a first half 1012-a of RBs (e.g., RBs 0-23) or second half a second half 1012-b of RBs (e.g., RBs 24-47) within a set of RBs for a first CORESET (e.g., CORESET0 RBs, such as RBs 0-47) where the RMSI PDCCH(s) 1004 and RMSI PDSCH(s) 1006 can occur. In some aspects, the RMSI PDSCH 1006 may be scheduled within the indicated RB range, where the exact RBs (e.g., frequency domain resource allocation (FDRA)) may be determined after the RMSI PDCCH 1004 has been decoded.

Additionally or alternatively, the MIB may include a second bit (e.g., one bit) indicating which transmission occasions of the set of transmission occasions 1002 where the RMSI PDCCH(s) 1004 and RMSI PDSCH(s) 1006 can occur. For example, the second bit may indicate a subset of the set of transmission occasions 1002 where the RMSI PDCCH(s) 1004 and RMSI PDSCH(s) 1006 can occur (e.g., even or odd SSB bursts among the eight possible transmission occasions 1002). Table 3 (provided below) includes different field values for the MIB and possible RB ranges and transmission occasions for each MIB field value.

TABLE 3
MIB Indication of Possible RB Range and Transmission Occasions

| MIB Field | Possible RB Range | Transmission Occasions |
|---|---|---|
| 00 | RB 0-23 | Even SSB Burst |
| 01 | RB 0-23 | Odd SSB Burst |
| 10 | RB 24-47 | Even SSB Burst |
| 11 | RB 24-47 | Odd SSB Burst |

Additionally, the MIB may assist the device to determine which PDCCH candidates should be combined among detected PDCCH candidates when two PDCCHs share a same search space. For example, the MIB may assist the device in differentiating a paging PDCCH 1010 from an RMSI PDCCH 1004 in the first transmission occasion 1002-a.

### Example Repetition Patterns for System Information

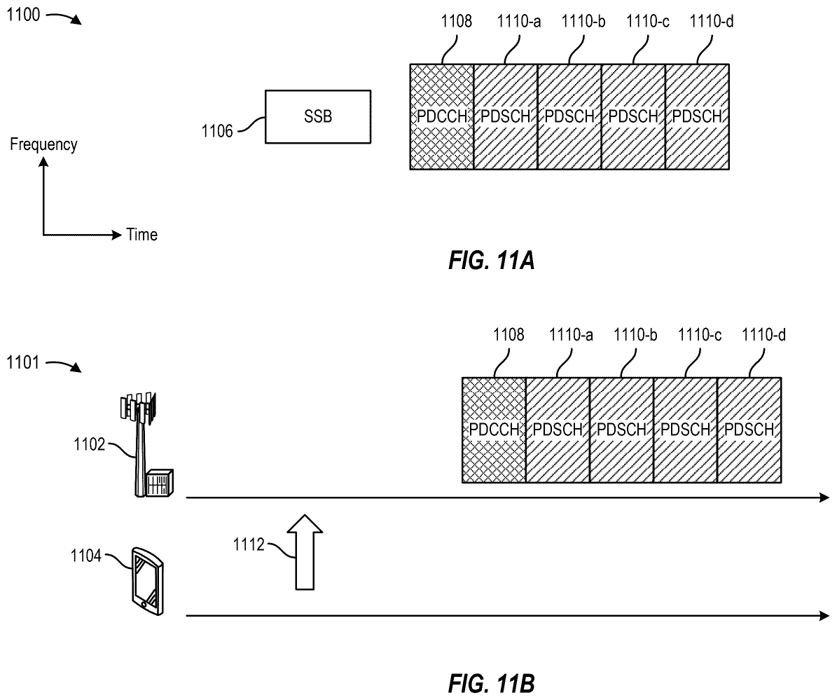

FIGS. 11A and 11B depict examples of repetition patterns 1100 and 1101, respectively, for enhancing coverage of downlink shared channels for system information via repetition in accordance with aspects of the present disclosure. In some aspects, the repetition patterns 1100 and 1101 may implement aspects of or may be implemented by aspects of FIGS. 1-4D and 6-7C. For example, the repetition patterns 1100 and 1101 may represent a device receiving signaling that is indicative of a number of repetitions for a PDSCH (e.g., to enable slot aggregation for an RMSI PDSCH and/or OSI PDSCH), where the PDSCH may include RMSI or OSI, as described with reference to FIG. 6.

In the example of FIG. 11A, the device may receive an SSB 1106, a PDCCH 1108, and one or more PDSCHs 1110 (e.g., according to SSB multiplexing pattern 1 as described with reference to FIG. 7A). As described herein, the PDCCH 1108 may include signaling indicative of a number of repetitions for the one or more PDSCHs 1110. For example, the number of repetitions may be four, such that the one or more PDSCHs 1110 include a first PDSCH 1110-a, a second PDSCH 1110-b, a third PDSCH 1110-c, and a fourth PDSCH 1110-d. Additionally, in the example of FIG. 11A, the one or more PDSCHs 1110 may include RMSI.

Additionally or alternatively, in the example of FIG. 11B, a device 1104 may send a request 1112 to a network entity 1102, where the request 1112 includes a request for OSI. Subsequently, after sending the request 1112, the device 1104 may receive the PDCCH 1108 and the one or more PDSCHs 1110. In some aspects, the PDCCH 1108 may include signaling indicative of the number of repetitions (e.g., four repetitions) for the one or more PDSCHs 1110. Additionally or alternatively, the device 1104 may determine the number of repetitions for the one or more PDSCHs 1110 based on a preamble identifier included in the request 1112 and/or in which transmission occasion that the request 1112 is sent (e.g., based on RRC semi-static configurations, which may be signaled through RMSI).

### Example Operations of Entities in a Communications Network for Enhancing Coverage of Downlink Shared Channels for System Information Via Combining and/or Repetition

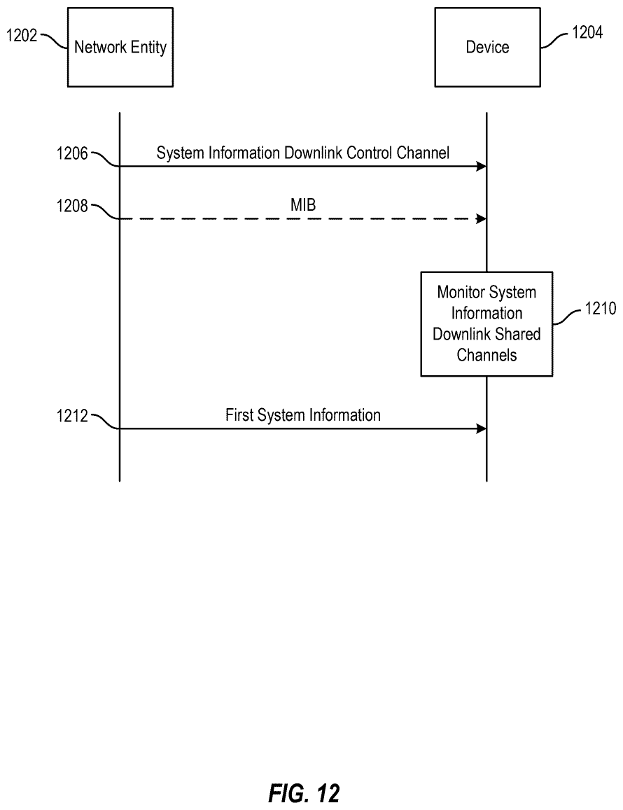

FIG. 12 depicts a process flow 1200 for communications in a network between a network entity and a device for enhancing coverage of downlink shared channels for system information via combination and/or repetition in accordance with aspects of the present disclosure. In some aspects, the process flow 1200 may implement aspects of or may be implemented by aspects of FIGS. 1-5 and 7A-10. For example, the process flow 1200 may include a network entity 1202 and at least one device 1204. The network entity 1202 may represent a base station or similar network entity as described with reference to FIGS. 1-3 and 5-11 (e.g., BS 102, BS 180, network entity 502, etc.) and the device 1204 may represent a UE or similar terminal device as described with reference to FIGS. 1-3 and 5-10 (e.g., UE 104, device 504, etc.). In some aspects, the process flow 1200 may represent communication of system information via combining and/or repetition as described with reference to FIG. 5. Note that any operations or signaling illustrated with dashed lines may indicate that that operation or signaling is an optional or alternative example.

At 1206, the device 1204 receives, in a first transmission occasion, a system information downlink control channel. In some aspects, the system information downlink control channel may include scheduling information for a plurality of system information downlink shared channels in a plurality of transmission occasions, where the plurality of transmission occasions includes the first transmission occasion (e.g., as described with reference to FIGS. 5 and 8). For example, the scheduling information may include a DCI. In some aspects, the DCI may indicate the plurality of transmission occasions. Additionally or alternatively, the scheduling information may include a TDRA table. In some aspects, the TDRA table may indicate the plurality of transmission occasions.

At 1208, the device 1204 may receive a MIB that includes additional scheduling information for system information comprising the system information downlink control channel and the plurality of system information downlink shared channels (e.g., as described with reference to FIGS. 5 and 10). For example, the additional scheduling information may include a first indication of a range of frequencies to monitor for the system information and/or a second indication of a subset of transmission occasions (e.g., of a set of transmission occasions) to monitor for the system information, where the subset of transmission occasions includes the plurality of transmission occasions. In some aspects, the range of frequencies may include a range of RBs (e.g., RBs 0-23 or RBs 24-47 or another range of RBs), and the subset of transmission occasions may include even-numbered transmission occasions or odd-numbered transmission occasions of the set of transmission occasions (e.g., or another subset of transmission occasions).

At 1210, the device 1204 monitors the plurality of system information downlink shared channels. In some aspects, a first number of time-frequency resources allocated for a first system information downlink shared channel of the plurality of system information downlink shared channels may be different than a second number of time-frequency resources allocated for a second system information downlink shared channel of the plurality of system information downlink shared channels. Additionally, each system information downlink shared channel of the plurality of system information downlink shared channels may be confined within a respective time resource allocation of a respective SSB in a respective transmission occasion of the plurality of transmission occasions (e.g., SSB multiplexing patterns 2 or 3 as described with reference to FIGS. 7B and 7C, respectively).

At 1212, the device 1204 receives first system information in the plurality of system information downlink shared channels based at least in part on monitoring the plurality of system information downlink shared channels. For example, the scheduling information may indicate time-frequency resources that are scheduled to carry the plurality of system information downlink shared channels, such that the device monitors the time-frequency resources for the plurality of system information downlink shared channels. Subsequently, based on monitoring the plurality of system information downlink shared channels, the device 1204 may detect encoded bits carrying the first system information and decode the bits to receive the first system information. In some aspects, the first system information may include RMSI.

In some aspects, the first system information may include a set of coded bits, and each of the plurality of system information downlink shared channels may include a respective instance of the set of coded bits (e.g., as described with reference to FIG. 9A). Additionally, a first modulation scheme applied to a first system information downlink shared channel of the plurality of system information downlink shared channels may be different than a second modulation scheme applied to a second system information downlink shared channel of the plurality of system information downlink shared channels. In some aspects, the system information downlink control channel may indicate a plurality of parameters. For example, the plurality of parameters may include a code rate that is common across the plurality of transmission occasions, a respective modulation scheme for each transmission occasion of the plurality of transmission occasions, a repetition parameter to indicate at least part of a set of coded bits that are repeated for one or more transmission occasions of the plurality of transmission occasions, or a combination thereof.

Additionally or alternatively, the first system information may include a set of coded bits, and the set of coded bits may be distributed across the plurality of system information downlink shared channels (e.g., as described with reference to FIG. 9B). In some aspects, the system information downlink control channel may include an indication of how the set of coded bits are distributed across the plurality of transmission occasions.

Note that the process flow illustrated in FIG. 12 is an example of enhancing coverage of downlink shared channels for system information via combining and/or repetition, and aspects of the present disclosure may be applied to enhancing coverage of downlink shared channels for system information via combining and/or repetition. Note that the process flow illustrated in FIG. 12 is described herein to facilitate an understanding of enhancing coverage of downlink shared channels for system information via combining and/or repetition and aspects of the present disclosure may be performed in various manners via alternative or additional signaling and/or operations. In certain aspects, the operations and/or signaling of FIG. 12 may occur in an order different from that described or depicted, and various actions, operations, and/or signaling may be added, omitted, or combined.

### Example Operations of Entities in a Communications Network for Enhancing Coverage of Downlink Shared Channels for System Information Via Repetition

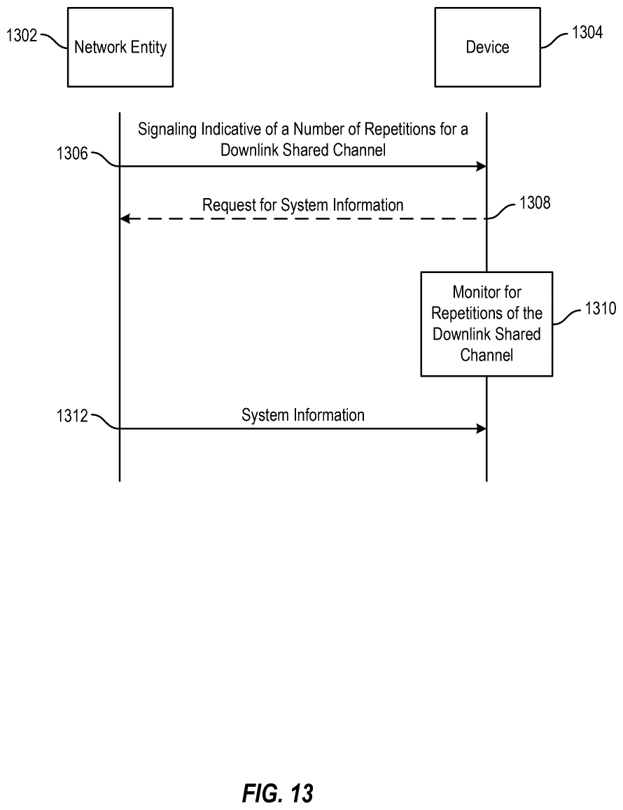

FIG. 13 depicts a process flow 1300 for communications in a network between a network entity and a device for enhancing coverage of downlink shared channels for system information via combination and/or repetition in accordance with aspects of the present disclosure. In some aspects, the process flow 1300 may implement aspects of or may be implemented by aspects of FIGS. 1-4D, 6, 7A-7C, and 11A-11B. For example, the process flow 1300 may include a network entity 1302 and at least one device 1304. The network entity 1302 may represent a base station or similar network entity as described with reference to FIGS. 1-3, 6, and 11A-11B (e.g., BS 102, BS 180, network entity 602, etc.) and the device 1304 may represent a UE or similar terminal device as described with reference to FIGS. 1-3, 6, and 11A-11B (e.g., UE 104, device 604, etc.). In some aspects, the process flow 1300 may represent communication of system information via repetition as described with reference to FIG. 6. Note that any operations or signaling illustrated with dashed lines may indicate that that operation or signaling is an optional or alternative example.

At 1306, the device 1304 receives signaling indicative of a number of repetitions for a downlink shared channel, where the downlink shared channel includes system information (e.g., as described with reference to FIGS. 6 and 11A-11B). In some aspects, the signaling indicative of the number of repetitions may include a DCI field in a downlink control channel. Additionally or alternatively, the signaling indicative of the number of repetitions may include a TDRA table in a downlink control channel, and the TDRA table may include a slot aggregation field indicating the number of repetitions. Additionally or alternatively, the signaling indicative of the number of repetitions may include RRC signaling, RMSI, or a combination thereof.

At 1308, the device 1304 may send a request for the system information (e.g., as described with reference to FIGS. 6 and 11B). For example, the request may include a PRACH message. In some aspects, the number of repetitions may be based at least in part on a preamble identifier included in the request, a transmission occasion in which the request is sent, or a combination thereof. For example, different numbers of repetitions may be semi-statically configured to be associated with different preamble identifiers and/or transmission occasions, such that the device 1304 determines the number of repetitions based on which preamble identifier the device 1304 uses for the request and/or in which transmission occasion the request is sent.

At 1310, the device 1304 monitors for repetitions of the downlink shared channel according to the number of repetitions. In some aspects, the repetitions of the downlink shared channel may be TDMed with an SSB (e.g., SSB multiplexing pattern 1 as described with reference to FIG. 7A).

At 1312, the device 1304 receives system information based at least in part on monitoring for the repetitions of the downlink shared channel according to the number of repetitions. In some aspects, the system information may include RMSI (e.g., as described with reference to FIGS. 6 and 11A). Additionally or alternatively, the system information may include OSI (e.g., as described with reference to FIGS. 6 and 11B).

Note that the process flow illustrated in FIG. 13 is an example of enhancing coverage of downlink shared channels for system information via repetition, and aspects of the present disclosure may be applied to enhancing coverage of downlink shared channels for system information via repetition. Note that the process flow illustrated in FIG. 13 is described herein to facilitate an understanding of enhancing coverage of downlink shared channels for system information via repetition, and aspects of the present disclosure may be performed in various manners via alternative or additional signaling and/or operations. In certain aspects, the operations and/or signaling of FIG. 13 may occur in an order different from that described or depicted, and various actions, operations, and/or signaling may be added, omitted, or combined.

### Example Operations of a User Equipment

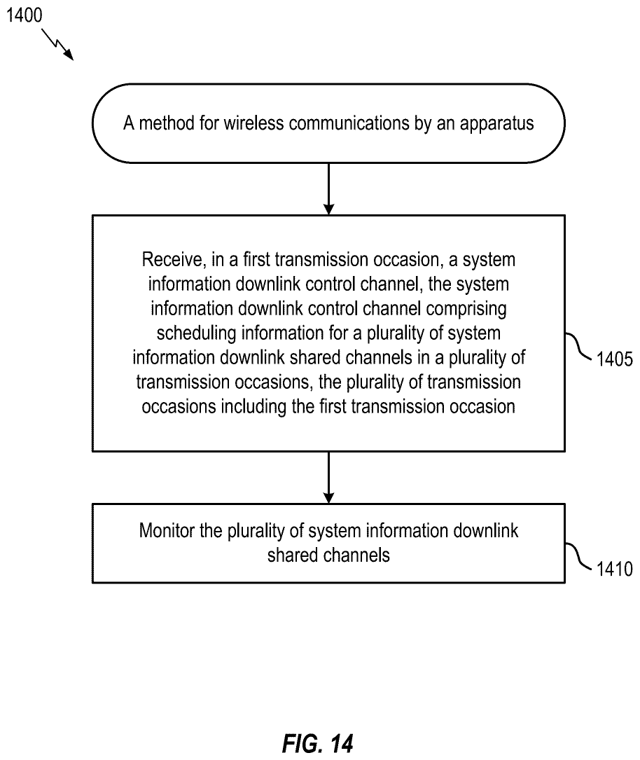

FIG. 14 shows a method 1400 for wireless communications by an apparatus, such as UE 104 of FIGS. 1 and 3.

Method 1400 begins at block 1405 with receiving, in a first transmission occasion, a system information downlink control channel (e.g., RMSI PDCCH 510 as described with reference to FIG. 5), the system information downlink control channel comprising scheduling information (e.g., scheduling information 512 as described with reference to FIG. 5) for a plurality of system information downlink shared channels (e.g., RMSI PDSCHs 514 as described with reference to FIG. 5) in a plurality of transmission occasions, the plurality of transmission occasions including the first transmission occasion.

Method 1400 then proceeds to block 1410 with monitoring the plurality of system information downlink shared channels.

In one aspect, the scheduling information comprises a DCI.

In one aspect, the DCI indicates the plurality of transmission occasions.

In one aspect, the TDRA table indicates the plurality of transmission occasions.

In one aspect, the scheduling information comprises a TDRA table.

In one aspect, a first number of time-frequency resources allocated for a first system information downlink shared channel of the plurality of system information downlink shared channels is different than a second number of time-frequency resources allocated for a second system information downlink shared channel of the plurality of system information downlink shared channels.

In one aspect, method 1400 further includes receiving first system information in the plurality of system information downlink shared channels based at least in part on monitoring the plurality of system information downlink shared channels.

In one aspect, the first system information comprises RMSI.

In one aspect, the first system information comprises a set of coded bits; and each of the plurality of system information downlink shared channels comprises a respective instance of the set of coded bits.

In one aspect, a first modulation scheme applied to a first system information downlink shared channel of the plurality of system information downlink shared channels is different than a second modulation scheme applied to a second system information downlink shared channel of the plurality of system information downlink shared channels.

In one aspect, a first system information downlink shared channel of the plurality of system information downlink shared channels includes the set of coded bits without repetition; and a second system information downlink shared channel of the plurality of system information downlink shared channels includes the set of coded bits with at least part of the set of coded bits repeated.

In one aspect, the system information downlink control channel indicates a plurality of parameters; and the plurality of parameters comprise: a code rate that is common across the plurality of transmission occasions; a respective modulation scheme for each transmission occasion of the plurality of transmission occasions; a repetition parameter to indicate at least part of a set of coded bits that are repeated for one or more transmission occasions of the plurality of transmission occasions; or a combination thereof.

In one aspect, the first system information comprises a set of coded bits; and the set of coded bits are distributed across the plurality of system information downlink shared channels.

In one aspect, the system information downlink control channel comprises an indication of how the set of coded bits are distributed across the plurality of transmission occasions.

In one aspect, method 1400 further includes receiving a MIB comprising additional scheduling information for system information comprising the system information downlink control channel and the plurality of system information downlink shared channels; the additional scheduling information comprises a first indication of a range of frequencies to monitor for the system information; and the additional scheduling information comprises a second indication of a subset of transmission occasions, of a set of transmission occasions, to monitor for the system information; and the subset of transmission occasions includes the plurality of transmission occasions.

In one aspect, the range of frequencies comprises a range of RBs; and the subset of transmission occasions comprises even-numbered transmission occasions or odd-numbered transmission occasions of the set of transmission occasions.

In one aspect, each system information downlink shared channel of the plurality of system information downlink shared channels is confined within a respective time resource allocation of a respective synchronization signal block in a respective transmission occasion of the plurality of transmission occasions.

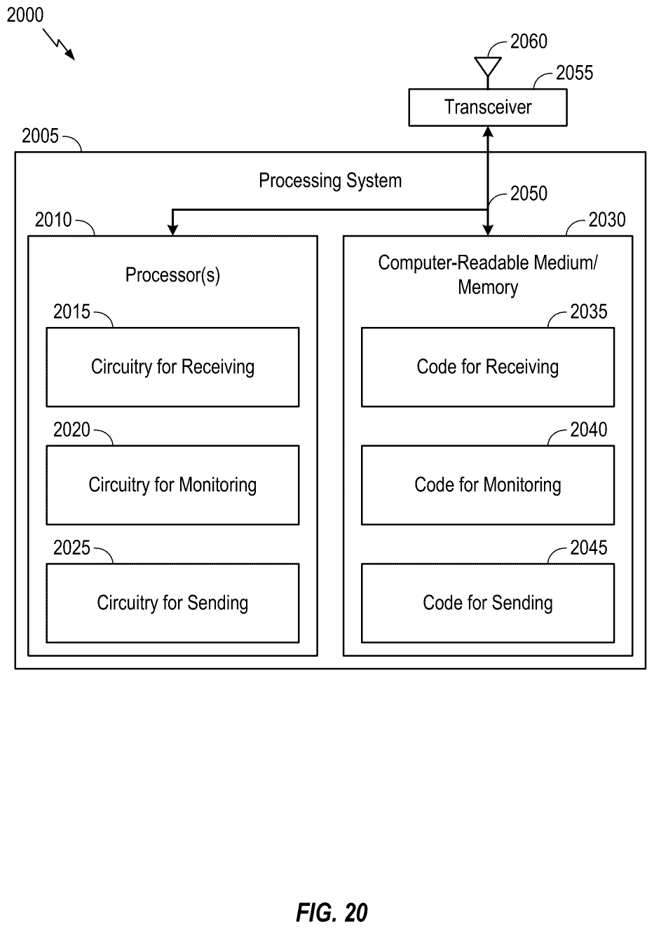

In one aspect, method 1400, or any aspect related to it, may be performed by an apparatus, such as communications device 2000 of FIG. 20, which includes various components operable, configured, or adapted to perform the method 1400. Communications device 2000 is described below in further detail.

Note that FIG. 14 is just one example of a method, and other methods including fewer, additional, or alternative operations are possible consistent with this disclosure.

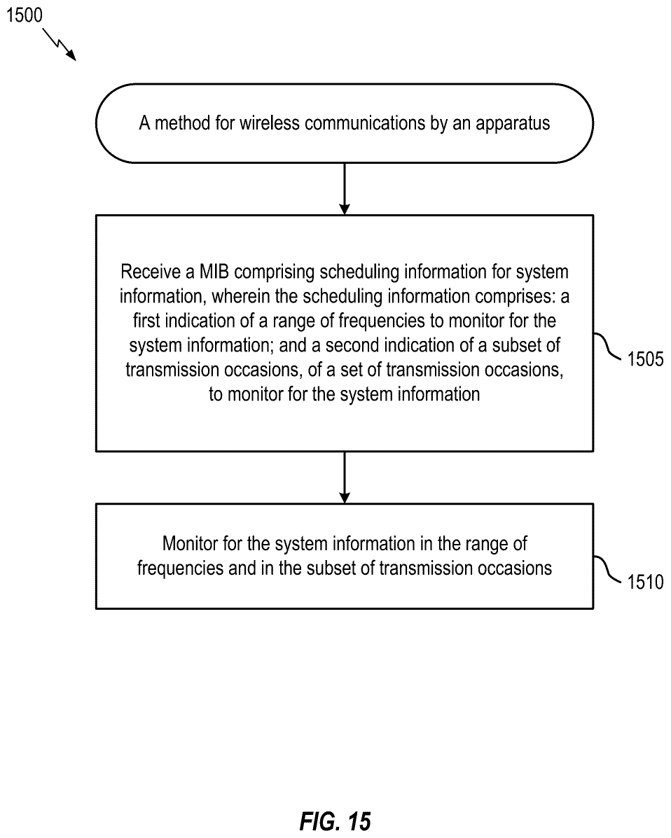

FIG. 15 shows a method 1500 for wireless communications by an apparatus, such as UE 104 of FIGS. 1 and 3.

Method 1500 begins at block 1505 with receiving a MIB (e.g., the MIB 516 as described with reference to FIG. 5) comprising scheduling information (e.g., the additional scheduling information 518 as described with reference to FIG. 5) for system information, wherein the scheduling information comprises: a first indication of a range of frequencies to monitor for the system information; and a second indication of a subset of transmission occasions, of a set of transmission occasions, to monitor for the system information.

Method 1500 then proceeds to block 1510 with monitoring for the system information in the range of frequencies and in the subset of transmission occasions.

In one aspect, the range of frequencies comprises a range of RBs; and the subset of transmission occasions comprises even-numbered transmission occasions or odd-numbered transmission occasions of the set of transmission occasions.

In one aspect, method 1500 further includes receiving the system information in at least a plurality of system information downlink shared channels in the subset of transmission occasions.

In one aspect, each system information downlink shared channel of the plurality of system information downlink shared channels is confined within a respective time resource allocation of a respective synchronization signal block in a respective transmission occasion of the subset of transmission occasions.

In one aspect, the system information comprises RMSI.

In one aspect, method 1500, or any aspect related to it, may be performed by an apparatus, such as communications device 2000 of FIG. 20, which includes various components operable, configured, or adapted to perform the method 1500. Communications device 2000 is described below in further detail.

Note that FIG. 15 is just one example of a method, and other methods including fewer, additional, or alternative operations are possible consistent with this disclosure.

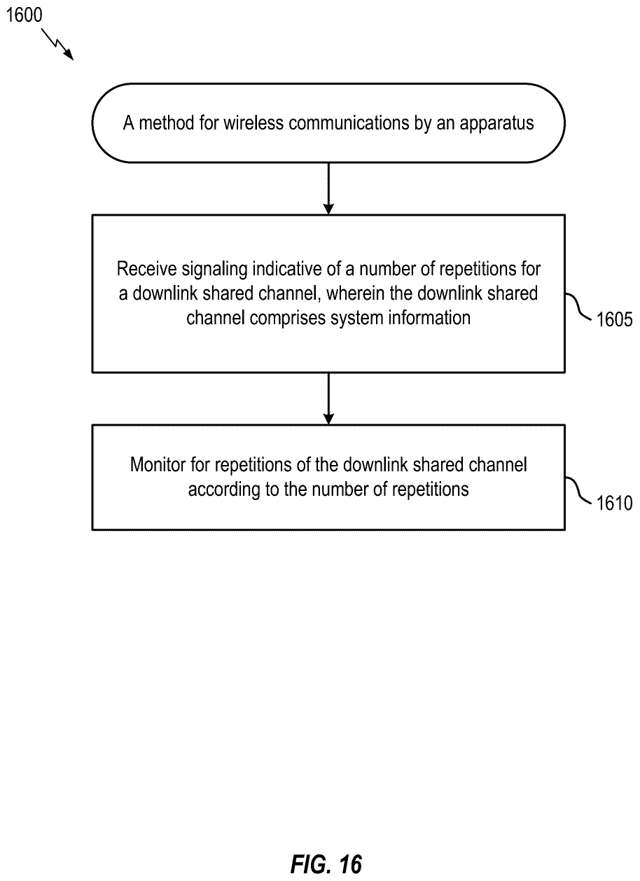

FIG. 16 shows a method 1600 for wireless communications by an apparatus, such as UE 104 of FIGS. 1 and 3.

Method 1600 begins at block 1605 with receiving signaling (e.g., the signaling 610 as described with reference to FIG. 6) indicative of a number of repetitions for a downlink shared channel (e.g., the PDSCH 614 as described with reference to FIG. 6), wherein the downlink shared channel comprises system information.

Method 1600 then proceeds to block 1610 with monitoring (e.g., the monitoring 612 as described with reference to FIG. 6) for repetitions of the downlink shared channel according to the number of repetitions.

In one aspect, the signaling indicative of the number of repetitions comprises a DCI field in a downlink control channel.

In one aspect, the signaling indicative of the number of repetitions comprises a TDRA table in a downlink control channel; and the TDRA table comprises a slot aggregation field indicating the number of repetitions.

In one aspect, the signaling indicative of the number of repetitions comprises RRC signaling, RMSI, or a combination thereof.

In one aspect, the system information comprises OSI.

In one aspect, method 1600 further includes sending a request for the system information.

In one aspect, the request comprises a PRACH message.

In one aspect, the number of repetitions is based at least in part on a preamble identifier included in the request, a transmission occasion in which the request is sent, or a combination thereof.

In one aspect, the repetitions of the downlink shared channel are TDMed with a synchronization signal block.

In one aspect, the system information comprises RMSI.

In one aspect, the system information comprises OSI.

In one aspect, method 1600, or any aspect related to it, may be performed by an apparatus, such as communications device 2000 of FIG. 20, which includes various components operable, configured, or adapted to perform the method 1600. Communications device 2000 is described below in further detail.

Note that FIG. 16 is just one example of a method, and other methods including fewer, additional, or alternative operations are possible consistent with this disclosure.

### Example Operations of a Network Entity

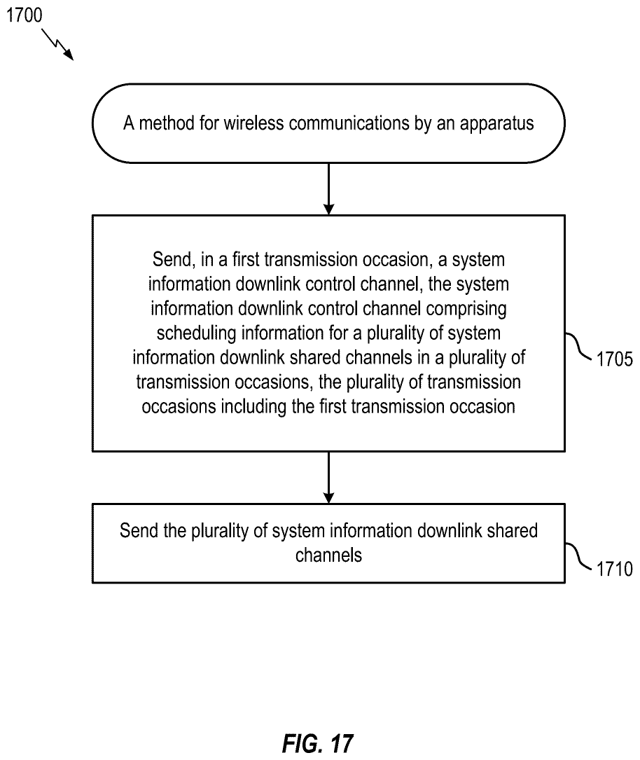

FIG. 17 shows a method 1700 for wireless communications by an apparatus, such as BS 102 of FIGS. 1 and 3, or a disaggregated base station as discussed with respect to FIG. 2.

Method 1700 begins at block 1705 with sending, in a first transmission occasion, a system information downlink control channel (e.g., RMSI PDCCH 510 as described with reference to FIG. 5), the system information downlink control channel comprising scheduling information (e.g., scheduling information 512 as described with reference to FIG. 5) for a plurality of system information downlink shared channels (e.g., RMSI PDSCHs 514 as described with reference to FIG. 5) in a plurality of transmission occasions, the plurality of transmission occasions including the first transmission occasion.

Method 1700 then proceeds to block 1710 with sending the plurality of system information downlink shared channels.

In one aspect, the scheduling information comprises a DCI.

In one aspect, the DCI indicates the plurality of transmission occasions.

In one aspect, the TDRA table indicates the plurality of transmission occasions.

In one aspect, the scheduling information comprises a TDRA table.

In one aspect, a first number of time-frequency resources allocated for a first system information downlink shared channel of the plurality of system information downlink shared channels is different than a second number of time-frequency resources allocated for a second system information downlink shared channel of the plurality of system information downlink shared channels.

In one aspect, method 1700 further includes sending first system information in the plurality of system information downlink shared channels based at least in part on monitoring the plurality of system information downlink shared channels.

In one aspect, the first system information comprises RMSI.

In one aspect, the first system information comprises a set of coded bits; and each of the plurality of system information downlink shared channels comprises a respective instance of the set of coded bits.

In one aspect, a first modulation scheme applied to a first system information downlink shared channel of the plurality of system information downlink shared channels is different than a second modulation scheme applied to a second system information downlink shared channel of the plurality of system information downlink shared channels.

In one aspect, a first system information downlink shared channel of the plurality of system information downlink shared channels includes the set of coded bits without repetition; and a second system information downlink shared channel of the plurality of system information downlink shared channels includes the set of coded bits with at least part of the set of coded bits repeated.

In one aspect, the system information downlink control channel indicates a plurality of parameters; and the plurality of parameters comprise: a code rate that is common across the plurality of transmission occasions; a respective modulation scheme for each transmission occasion of the plurality of transmission occasions; a repetition parameter to indicate at least part of a set of coded bits that are repeated for one or more transmission occasions of the plurality of transmission occasions; or a combination thereof.

In one aspect, the first system information comprises a set of coded bits; and the set of coded bits are distributed across the plurality of system information downlink shared channels.

In one aspect, the system information downlink control channel comprises an indication of how the set of coded bits are distributed across the plurality of transmission occasions.

In one aspect, method 1700 further includes sending a MIB comprising additional scheduling information for system information comprising the system information downlink control channel and the plurality of system information downlink shared channels; the additional scheduling information comprises a first indication of a range of frequencies for a device to monitor for the system information; and the additional scheduling information comprises a second indication of a subset of transmission occasions, of a set of transmission occasions, for the device to monitor for the system information; and the subset of transmission occasions includes the plurality of transmission occasions.

In one aspect, the range of frequencies comprises a range of RBs; and the subset of transmission occasions comprises even-numbered transmission occasions or odd-numbered transmission occasions of the set of transmission occasions.

In one aspect, each system information downlink shared channel of the plurality of system information downlink shared channels is confined within a respective time resource allocation of a respective synchronization signal block in a respective transmission occasion of the plurality of transmission occasions.

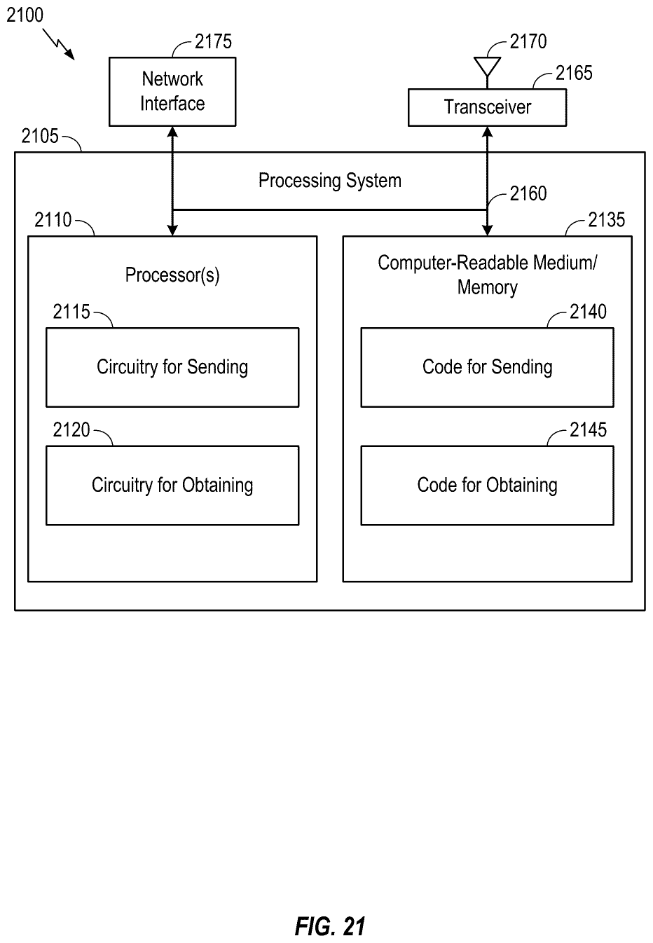

In one aspect, method 1700, or any aspect related to it, may be performed by an apparatus, such as communications device 2100 of FIG. 21, which includes various components operable, configured, or adapted to perform the method 1700. Communications device 2100 is described below in further detail.

Note that FIG. 17 is just one example of a method, and other methods including fewer, additional, or alternative operations are possible consistent with this disclosure.

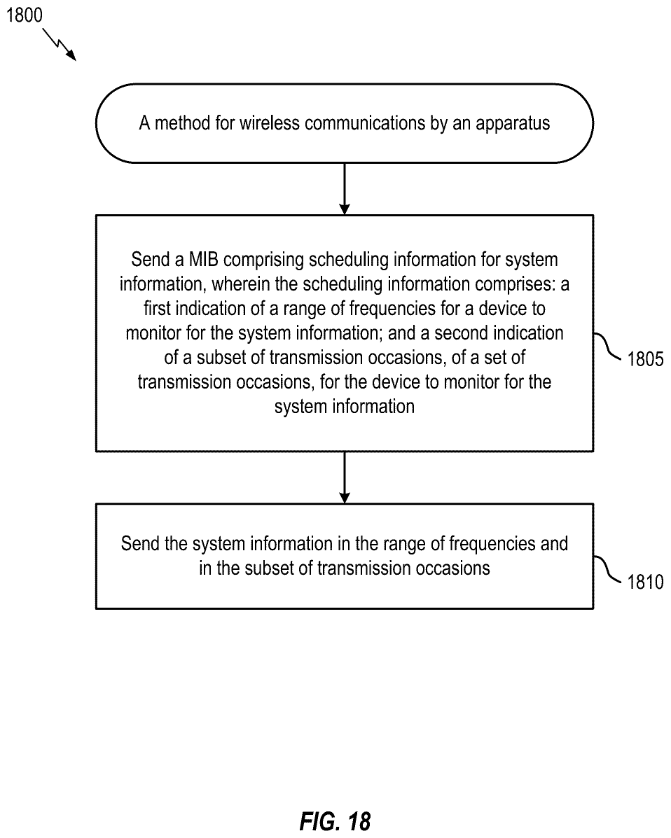

FIG. 18 shows a method 1800 for wireless communications by an apparatus, such as BS 102 of FIGS. 1 and 3, or a disaggregated base station as discussed with respect to FIG. 2.

Method 1800 begins at block 1805 with sending a MIB (e.g., the MIB 516 as described with reference to FIG. 5) comprising scheduling information (e.g., the additional scheduling information 518 as described with reference to FIG. 5) for system information, wherein the scheduling information comprises: a first indication of a range of frequencies to monitor for the system information; and a second indication of a subset of transmission occasions, of a set of transmission occasions, to monitor for the system information.

Method 1800 then proceeds to block 1810 with sending the system information in the range of frequencies and in the subset of transmission occasions.

In one aspect, the range of frequencies comprises a range of RBs; and the subset of transmission occasions comprises even-numbered transmission occasions or odd-numbered transmission occasions of the set of transmission occasions.

In one aspect, method 1800 further includes sending the system information in at least a plurality of system information downlink shared channels in the subset of transmission occasions.

In one aspect, each system information downlink shared channel of the plurality of system information downlink shared channels is confined within a respective time resource allocation of a respective synchronization signal block in a respective transmission occasion of the subset of transmission occasions.

In one aspect, the system information comprises RMSI.

In one aspect, method 1800, or any aspect related to it, may be performed by an apparatus, such as communications device 2100 of FIG. 21, which includes various components operable, configured, or adapted to perform the method 1800. Communications device 2100 is described below in further detail.

Note that FIG. 18 is just one example of a method, and other methods including fewer, additional, or alternative operations are possible consistent with this disclosure.

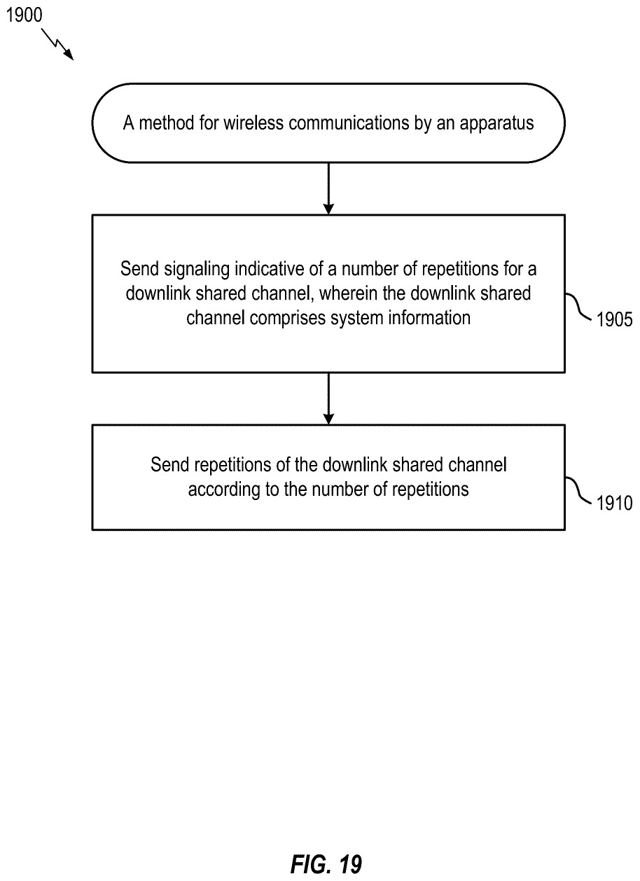

FIG. 19 shows a method 1900 for wireless communications by an apparatus, such as BS 102 of FIGS. 1 and 3, or a disaggregated base station as discussed with respect to FIG. 2.

Method 1900 begins at block 1905 with sending signaling (e.g., the signaling 610 as described with reference to FIG. 6) indicative of a number of repetitions for a downlink shared channel (e.g., the PDSCH 614 as described with reference to FIG. 6), wherein the downlink shared channel comprises system information.

Method 1900 then proceeds to block 1910 with sending repetitions of the downlink shared channel according to the number of repetitions.

In one aspect, the signaling indicative of the number of repetitions comprises a DCI field in a downlink control channel.

In one aspect, the signaling indicative of the number of repetitions comprises a TDRA table in a downlink control channel; and the TDRA table comprises a slot aggregation field indicating the number of repetitions.

In one aspect, the signaling indicative of the number of repetitions comprises RRC signaling, RMSI, or a combination thereof.

In one aspect, the system information comprises OSI.

In one aspect, method 1900 further includes obtaining a request for the system information.

In one aspect, the request comprises a PRACH message.

In one aspect, the number of repetitions is based at least in part on a preamble identifier included in the request, a transmission occasion in which the request is sent, or a combination thereof.

In one aspect, the repetitions of the downlink shared channel are TDMed with a synchronization signal block.

In one aspect, the system information comprises RMSI.

In one aspect, the system information comprises OSI.

In one aspect, method 1900, or any aspect related to it, may be performed by an apparatus, such as communications device 2100 of FIG. 21, which includes various components operable, configured, or adapted to perform the method 1900. Communications device 2100 is described below in further detail.

Note that FIG. 19 is just one example of a method, and other methods including fewer, additional, or alternative operations are possible consistent with this disclosure.

### Example Communications Device

FIG. 20 depicts aspects of an example communications device 2000. In some aspects, communications device 2000 is a user equipment, such as UE 104 described above with respect to FIGS. 1 and 3.

The communications device 2000 includes a processing system 2005 coupled to a transceiver 2055 (e.g., a transmitter and/or a receiver). The transceiver 2055 is configured to transmit and receive signals for the communications device 2000 via an antenna 2060, such as the various signals as described herein. The processing system 2005 may be configured to perform processing functions for the communications device 2000, including processing signals received and/or to be transmitted by the communications device 2000.

The processing system 2005 includes one or more processors 2010. In various aspects, the one or more processors 2010 may be representative of one or more of receive processor 358, transmit processor 364, TX MIMO processor 366, and/or controller/processor 380, as described with respect to FIG. 3. The one or more processors 2010 are coupled to a computer-readable medium/memory 2030 via a bus 2050. In certain aspects, the computer-readable medium/memory 2030 is configured to store instructions (e.g., computer-executable code), including code 2035-2045, that when executed by the one or more processors 2010, enable and cause the one or more processors 2010 to perform the method 1400 described with respect to FIG. 14, or any aspect related to it, including any operations described in relation to FIG. 14; the method 1500 described with respect to FIG. 15, or any aspect related to it, including any operations described in relation to FIG. 15; and the method 1600 described with respect to FIG. 16, or any aspect related to it, including any operations described in relation to FIG. 16. Note that reference to a processor performing a function of communications device 2000 may include one or more processors performing that function of communications device 2000, such as in a distributed fashion.

In the depicted example, computer-readable medium/memory 2030 stores code for receiving 2035, code for monitoring 2040, and code for sending 2045. Processing of the code 2035-2045 may enable and cause the communications device 2000 to perform the method 1400 described with respect to FIG. 14, or any aspect related to it; the method 1500 described with respect to FIG. 15, or any aspect related to it; and the method 1600 described with respect to FIG. 16, or any aspect related to it.

The one or more processors 2010 include circuitry configured to implement (e.g., execute) the code (e.g., executable instructions) stored in the computer-readable medium/memory 2030, including circuitry for receiving 2015, circuitry for monitoring 2020, and circuitry for sending 2025. Processing with circuitry 2015-2025 may enable and cause the communications device 2000 to perform the method 1400 described with respect to FIG. 14, or any aspect related to it; the method 1500 described with respect to FIG. 15, or any aspect related to it; and the method 1600 described with respect to FIG. 16, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 2055 and/or antenna 2060 of the communications device 2000 in FIG. 20, and/or one or more processors 2010 of the communications device 2000 in FIG. 20. Means for communicating, receiving or obtaining may include the transceivers 354, antenna(s) 352, receive processor 358, AI processor 370, and/or controller/processor 380 of the UE 104 illustrated in FIG. 3, transceiver 2055 and/or antenna 2060 of the communications device 2000 in FIG. 20, and/or one or more processors 2010 of the communications device 2000 in FIG. 20.

FIG. 21 depicts aspects of an example communications device 2100. In some aspects, communications device 2100 is a network entity, such as BS 102 of FIGS. 1 and 3, or a disaggregated base station as discussed with respect to FIG. 2.

The communications device 2100 includes a processing system 2105 coupled to a transceiver 2165 (e.g., a transmitter and/or a receiver) and/or a network interface 2175. The transceiver 2165 is configured to transmit and receive signals for the communications device 2100 via an antenna 2170, such as the various signals as described herein. The network interface 2175 is configured to obtain and send signals for the communications device 2100 via communications link(s), such as a backhaul link, midhaul link, and/or fronthaul link as described herein, such as with respect to FIG. 2. The processing system 2105 may be configured to perform processing functions for the communications device 2100, including processing signals received and/or to be transmitted by the communications device 2100.

The processing system 2105 includes one or more processors 2110. In various aspects, one or more processors 2110 may be representative of one or more of receive processor 338, transmit processor 320, TX MIMO processor 330, and/or controller/processor 340, as described with respect to FIG. 3. The one or more processors 2110 are coupled to a computer-readable medium/memory 2135 via a bus 2160. In certain aspects, the computer-readable medium/memory 2135 is configured to store instructions (e.g., computer-executable code), including code 2140-2145, that when executed by the one or more processors 2110, enable and cause the one or more processors 2110 to perform the method 1700 described with respect to FIG. 17, or any aspect related to it, including any operations described in relation to FIG. 17; the method 1800 described with respect to FIG. 18, or any aspect related to it, including any operations described in relation to FIG. 18; and the method 1900 described with respect to FIG. 19, or any aspect related to it, including any operations described in relation to FIG. 19. Note that reference to a processor of communications device 2100 performing a function may include one or more processors of communications device 2100 performing that function, such as in a distributed fashion.

In the depicted example, the computer-readable medium/memory 2135 stores code for sending 2140 and code for obtaining 2145. Processing of the code 2140-2145 may enable and cause the communications device 2100 to perform the method 1700 described with respect to FIG. 17, or any aspect related to it; the method 1800 described with respect to FIG. 18, or any aspect related to it; and the method 1900 described with respect to FIG. 19, or any aspect related to it.

The one or more processors 2110 include circuitry configured to implement (e.g., execute) the code (e.g., executable instructions) stored in the computer-readable medium/memory 2135, including circuitry for sending 2115 and circuitry for obtaining 2120. Processing with circuitry 2115-2120 may enable and cause the communications device 2100 to perform the method 1700 described with respect to FIG. 17, or any aspect related to it; the method 1800 described with respect to FIG. 18, or any aspect related to it; and the method 1900 described with respect to FIG. 19, or any aspect related to it.

Various components of the communications device 2100 may provide means for performing the method 1700 described with respect to FIG. 17, or any aspect related to it; the method 1800 described with respect to FIG. 18, or any aspect related to it; and the method 1900 described with respect to FIG. 19, or any aspect related to it. Means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 2165, antenna 2170, and/or network interface 2175 of the communications device 2100 in FIG. 21, and/or one or more processors 2110 of the communications device 2100 in FIG. 21. Means for communicating, receiving or obtaining may include the transceivers 332, antenna(s) 334, receive processor 338, AI processor 318, and/or controller/processor 340 of the BS 102 illustrated in FIG. 3, transceiver 2165, antenna 2170, and/or network interface 2175 of the communications device 2100 in FIG. 21, and/or one or more processors 2110 of the communications device 2100 in FIG. 21.

### EXAMPLE CLAUSES

Implementation examples are described in the following numbered clauses:

Clause 1: A method for wireless communications by an apparatus comprising: receiving, in a first transmission occasion, a system information downlink control channel, the system information downlink control channel comprising scheduling information for a plurality of system information downlink shared channels in a plurality of transmission occasions, the plurality of transmission occasions including the first transmission occasion; and monitoring the plurality of system information downlink shared channels.

Clause 2: The method of Clause 1, wherein the scheduling information comprises a DCI.

Clause 3: The method of Clause 2, wherein the DCI indicates the plurality of transmission occasions.

Clause 4: The method of any one of Clauses 1-3, wherein the scheduling information comprises a TDRA table.

Clause 5: The method of Clause 3, wherein the TDRA table indicates the plurality of transmission occasions.

Clause 6: The method of any one of Clauses 1-5, wherein a first number of time-frequency resources allocated for a first system information downlink shared channel of the plurality of system information downlink shared channels is different than a second number of time-frequency resources allocated for a second system information downlink shared channel of the plurality of system information downlink shared channels.

Clause 7: The method of any one of Clauses 1-6, further comprising receiving first system information in the plurality of system information downlink shared channels based at least in part on monitoring the plurality of system information downlink shared channels.

Clause 8: The method of Clause 7, wherein the first system information comprises RMSI.

Clause 9: The method of Clause 7, wherein: the first system information comprises a set of coded bits; and each of the plurality of system information downlink shared channels comprises a respective instance of the set of coded bits.

Clause 10: The method of Clause 9, wherein a first modulation scheme applied to a first system information downlink shared channel of the plurality of system information downlink shared channels is different than a second modulation scheme applied to a second system information downlink shared channel of the plurality of system information downlink shared channels.

Clause 11: The method of Clause 9, wherein: a first system information downlink shared channel of the plurality of system information downlink shared channels includes the set of coded bits without repetition; and a second system information downlink shared channel of the plurality of system information downlink shared channels includes the set of coded bits with at least part of the set of coded bits repeated.

Clause 12: The method of Clause 9, wherein: the system information downlink control channel indicates a plurality of parameters; and the plurality of parameters comprise: a code rate that is common across the plurality of transmission occasions; a respective modulation scheme for each transmission occasion of the plurality of transmission occasions; a repetition parameter to indicate at least part of a set of coded bits that are repeated for one or more transmission occasions of the plurality of transmission occasions; or a combination thereof.

Clause 13: The method of Clause 7, wherein: the first system information comprises a set of coded bits; and the set of coded bits are distributed across the plurality of system information downlink shared channels.

Clause 14: The method of Clause 13, wherein the system information downlink control channel comprises an indication of how the set of coded bits are distributed across the plurality of transmission occasions.

Clause 15: The method of any one of Clauses 1-14, further comprising receiving a MIB comprising additional scheduling information for system information comprising the system information downlink control channel and the plurality of system information downlink shared channels; the additional scheduling information comprises a first indication of a range of frequencies to monitor for the system information; and the additional scheduling information comprises a second indication of a subset of transmission occasions, of a set of transmission occasions, to monitor for the system information; and the subset of transmission occasions includes the plurality of transmission occasions.

Clause 16: The method of Clause 15, wherein: the range of frequencies comprises a range of RBs; and the subset of transmission occasions comprises even-numbered transmission occasions or odd-numbered transmission occasions of the set of transmission occasions.

Clause 17: The method of any one of Clauses 1-16, wherein each system information downlink shared channel of the plurality of system information downlink shared channels is confined within a respective time resource allocation of a respective synchronization signal block in a respective transmission occasion of the plurality of transmission occasions.

Clause 18: A method for wireless communications by an apparatus comprising: receiving a MIB comprising scheduling information for system information, wherein the scheduling information comprises: a first indication of a range of frequencies to monitor for the system information; and a second indication of a subset of transmission occasions, of a set of transmission occasions, to monitor for the system information; and monitoring for the system information in the range of frequencies and in the subset of transmission occasions.

Clause 19: The method of Clause 18, wherein: the range of frequencies comprises a range of RBs; and the subset of transmission occasions comprises even-numbered transmission occasions or odd-numbered transmission occasions of the set of transmission occasions.

Clause 20: The method of any one of Clauses 18-19, further comprising receiving the system information in at least a plurality of system information downlink shared channels in the subset of transmission occasions.

Clause 21: The method of any one of Clauses 18-20, wherein each system information downlink shared channel of the plurality of system information downlink shared channels is confined within a respective time resource allocation of a respective synchronization signal block in a respective transmission occasion of the subset of transmission occasions.

Clause 22: The method of any one of Clauses 18-21, wherein the system information comprises RMSI.

Clause 23: A method for wireless communications by an apparatus comprising: receiving signaling indicative of a number of repetitions for a downlink shared channel, wherein the downlink shared channel comprises system information; and monitoring for repetitions of the downlink shared channel according to the number of repetitions.

Clause 24: The method of Clause 23, wherein the signaling indicative of the number of repetitions comprises a DCI field in a downlink control channel.

Clause 25: The method of any one of Clauses 23-24, wherein: the signaling indicative of the number of repetitions comprises a TDRA table in a downlink control channel; and the TDRA table comprises a slot aggregation field indicating the number of repetitions.

Clause 26: The method of any one of Clauses 23-25, wherein the signaling indicative of the number of repetitions comprises RRC signaling, RMSI, or a combination thereof.

Clause 27: The method of Clause 26, wherein the system information comprises OSI.

Clause 28: The method of any one of Clauses 23-27, further comprising sending a request for the system information.

Clause 29: The method of Clause 28, wherein the request comprises a PRACH message.

Clause 30: The method of Clause 28, wherein the number of repetitions is based at least in part on a preamble identifier included in the request, a transmission occasion in which the request is sent, or a combination thereof.

Clause 31: The method of any one of Clauses 23-30, wherein the repetitions of the downlink shared channel are TDMed with a synchronization signal block.

Clause 32: The method of any one of Clauses 23-31, wherein the system information comprises RMSI.

Clause 33: The method of any one of Clauses 23-32, wherein the system information comprises OSI.

Clause 34: A method for wireless communications by an apparatus comprising: sending, in a first transmission occasion, a system information downlink control channel, the system information downlink control channel comprising scheduling information for a plurality of system information downlink shared channels in a plurality of transmission occasions, the plurality of transmission occasions including the first transmission occasion; and sending the plurality of system information downlink shared channels.

Clause 35: The method of Clause 34, wherein the scheduling information comprises a DCI.

Clause 36: The method of Clause 35, wherein the DCI indicates the plurality of transmission occasions.

Clause 37: The method of any one of Clauses 34-36, wherein the scheduling information comprises a TDRA table.

Clause 38: The method of Clause 37, wherein the TDRA table indicates the plurality of transmission occasions.

Clause 39: The method of any one of Clauses 34-38, wherein a first number of time-frequency resources allocated for a first system information downlink shared channel of the plurality of system information downlink shared channels is different than a second number of time-frequency resources allocated for a second system information downlink shared channel of the plurality of system information downlink shared channels.

Clause 40: The method of any one of Clauses 34-39, further comprising sending first system information in the plurality of system information downlink shared channels based at least in part on monitoring the plurality of system information downlink shared channels.

Clause 41: The method of Clause 40, wherein the first system information comprises RMSI.

Clause 42: The method of any one of Clauses 40-41, wherein: the first system information comprises a set of coded bits; and each of the plurality of system information downlink shared channels comprises a respective instance of the set of coded bits.

Clause 43: The method of Clause 42, wherein a first modulation scheme applied to a first system information downlink shared channel of the plurality of system information downlink shared channels is different than a second modulation scheme applied to a second system information downlink shared channel of the plurality of system information downlink shared channels.

Clause 44: The method of any one of Clauses 42-43, wherein: a first system information downlink shared channel of the plurality of system information downlink shared channels includes the set of coded bits without repetition; and a second system information downlink shared channel of the plurality of system information downlink shared channels includes the set of coded bits with at least part of the set of coded bits repeated.

Clause 45: The method of any one of Clauses 42-44, wherein: the system information downlink control channel indicates a plurality of parameters; and the plurality of parameters comprise: a code rate that is common across the plurality of transmission occasions; a respective modulation scheme for each transmission occasion of the plurality of transmission occasions; a repetition parameter to indicate at least part of a set of coded bits that are repeated for one or more transmission occasions of the plurality of transmission occasions; or a combination thereof.

Clause 46: The method of any one of Clauses 40-45, wherein: the first system information comprises a set of coded bits; and the set of coded bits are distributed across the plurality of system information downlink shared channels.

Clause 47: The method of Clause 46, wherein the system information downlink control channel comprises an indication of how the set of coded bits are distributed across the plurality of transmission occasions.

Clause 48: The method of any one of Clauses 34-47, further comprising sending a MIB comprising additional scheduling information for system information comprising the system information downlink control channel and the plurality of system information downlink shared channels; wherein the additional scheduling information comprises a first indication of a range of frequencies to monitor for the system information; and wherein the additional scheduling information comprises a second indication of a subset of transmission occasions, of a set of transmission occasions, to monitor for the system information; and wherein the subset of transmission occasions includes the plurality of transmission occasions.

Clause 49: The method of Clause 48, wherein: the range of frequencies comprises a range of RBs; and the subset of transmission occasions comprises even-numbered transmission occasions or odd-numbered transmission occasions of the set of transmission occasions.

Clause 50: The method of any one of Clauses 34-49, wherein each system information downlink shared channel of the plurality of system information downlink shared channels is confined within a respective time resource allocation of a respective synchronization signal block in a respective transmission occasion of the plurality of transmission occasions.

Clause 51: A method for wireless communications by an apparatus comprising: sending a MIB comprising scheduling information for system information, wherein the scheduling information comprises: a first indication of a range of frequencies for a device to monitor for the system information; and a second indication of a subset of transmission occasions, of a set of transmission occasions, for the device to monitor for the system information; and sending the system information in the range of frequencies and in the subset of transmission occasions.

Clause 52: The method of Clause 51, wherein: the range of frequencies comprises a range of RBs; and the subset of transmission occasions comprises even-numbered transmission occasions or odd-numbered transmission occasions of the set of transmission occasions.

Clause 53: The method of any one of Clauses 51-52, further comprising sending the system information in at least a plurality of system information downlink shared channels in the subset of transmission occasions.

Clause 54: The method of any one of Clauses 51-53, wherein each system information downlink shared channel of the plurality of system information downlink shared channels is confined within a respective time resource allocation of a respective synchronization signal block in a respective transmission occasion of the subset of transmission occasions.

Clause 55: The method of any one of Clauses 51-54, wherein the system information comprises RMSI.

Clause 56: A method for wireless communications by an apparatus comprising: sending signaling indicative of a number of repetitions for a downlink shared channel, wherein the downlink shared channel comprises system information; and sending repetitions of the downlink shared channel according to the number of repetitions.

Clause 57: The method of Clause 56, wherein the signaling indicative of the number of repetitions comprises a DCI field in a downlink control channel.

Clause 58: The method of any one of Clauses 56-57, wherein: the signaling indicative of the number of repetitions comprises a TDRA table in a downlink control channel; and the TDRA table comprises a slot aggregation field indicating the number of repetitions.

Clause 59: The method of any one of Clauses 56-58, wherein the signaling indicative of the number of repetitions comprises RRC signaling, RMSI, or a combination thereof.

Clause 60: The method of Clause 59, wherein the system information comprises OSI.

Clause 61: The method of any one of Clauses 56-60, further comprising obtaining a request for the system information.

Clause 62: The method of Clause 61, wherein the request comprises a PRACH message.

Clause 63: The method of Clause 61, wherein the number of repetitions is based at least in part on a preamble identifier included in the request, a transmission occasion in which the request is sent, or a combination thereof.

Clause 64: The method of any one of Clauses 56-63, wherein the repetitions of the downlink shared channel are TDMed with a synchronization signal block.

Clause 65: The method of any one of Clauses 56-64, wherein the system information comprises RMSI.

Clause 66: The method of any one of Clauses 56-65, wherein the system information comprises OSI.

Clause 67: One or more apparatuses, comprising: one or more memories comprising executable instructions; and one or more processors configured to execute the executable instructions and cause the one or more apparatuses to perform a method in accordance with any one of Clauses 1-66.

Clause 68: One or more apparatuses, comprising: one or more memories; and one or more processors, coupled to the one or more memories, configured to cause the one or more apparatuses to perform a method in accordance with any one of Clauses 1-66.

Clause 69: One or more apparatuses, comprising: one or more memories; and one or more processors, coupled to the one or more memories, configured to perform a method in accordance with any one of Clauses 1-66.

Clause 70: One or more apparatuses, comprising means for performing a method in accordance with any one of Clauses 1-66.

Clause 71: One or more non-transitory computer-readable media comprising executable instructions that, when executed by one or more processors of one or more apparatuses, cause the one or more apparatuses to perform a method in accordance with any one of Clauses 1-66.

Clause 72: One or more computer program products embodied on one or more computer-readable storage media comprising code for performing a method in accordance with any one of Clauses 1-66.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising: one or more memories; and one or more processors, coupled to the one or more memories, configured to cause the apparatus to:
receive signaling indicative of a number of repetitions for a downlink shared channel, wherein the downlink shared channel comprises system information; and
monitor for repetitions of the downlink shared channel according to the number of repetitions.

2. The apparatus of claim 1, wherein the signaling indicative of the number of repetitions comprises a downlink control information (DCI) field in a downlink control channel.

3. The apparatus of claim 1, wherein:
the signaling indicative of the number of repetitions comprises a time-domain resource allocation (TDRA) table in a downlink control channel; and
the time-domain resource allocation (TDRA) table comprises a slot aggregation field indicating the number of repetitions.

4. The apparatus of claim 1, wherein the signaling indicative of the number of repetitions comprises radio resource control (RRC) signaling, remaining minimum system information (RMSI), or a combination thereof.

5. The apparatus of claim 4, wherein the system information comprises other system information (OSI).

6. The apparatus of claim 1, wherein the one or more processors are configured to cause the apparatus to send a request for the system information.

7. The apparatus of claim 6, wherein the request comprises a physical random access channel (PRACH) message.

8. The apparatus of claim 6, wherein the number of repetitions is based at least in part on a preamble identifier included in the request, a transmission occasion in which the request is sent, or a combination thereof.

9. The apparatus of claim 1, wherein the repetitions of the downlink shared channel are time-division multiplexed (TDMed) with a synchronization signal block.

10. The apparatus of claim 1, wherein the system information comprises remaining minimum system information (RMSI).

11. The apparatus of claim 1, wherein the system information comprises other system information (OSI).

12. An apparatus configured for wireless communications, comprising: one or more memories; and one or more processors, coupled to the one or more memories, configured to cause the apparatus to:
send signaling indicative of a number of repetitions for a downlink shared channel, wherein the downlink shared channel comprises system information; and
send repetitions of the downlink shared channel according to the number of repetitions.

13. The apparatus of claim 12, wherein the signaling indicative of the number of repetitions comprises a downlink control information (DCI) field in a downlink control channel.

14. The apparatus of claim 12, wherein:
the signaling indicative of the number of repetitions comprises a time-domain resource allocation (TDRA) table in a downlink control channel; and
the time-domain resource allocation (TDRA) table comprises a slot aggregation field indicating the number of repetitions.

15. The apparatus of claim 12, wherein the signaling indicative of the number of repetitions comprises radio resource control (RRC) signaling, remaining minimum system information (RMSI), or a combination thereof.

16. The apparatus of claim 15, wherein the system information comprises other system information (OSI).

17. The apparatus of claim 12, wherein the one or more processors are configured to cause the apparatus to obtain a request for the system information.

18. The apparatus of claim 17, wherein the request comprises a physical random access channel (PRACH) message.

19. The apparatus of claim 17, wherein the number of repetitions is based at least in part on a preamble identifier included in the request, a transmission occasion in which the request is sent, or a combination thereof.

20. The apparatus of claim 12, wherein the repetitions of the downlink shared channel are time-division multiplexed (TDMed) with a synchronization signal block.
